(19) United States
(12) Patent Application Publication
(10) Pub. No.: US 2023/0259982 A1
(43) Pub. Date: Aug. 17, 2023

(54) Using Blockchain to Secure, Organize, Track, and Distribute Advertisement Information

(71) Applicant: LottoAds Inc., Ball Ground, GA (US)

(72) Inventor: Neal Harley Landers, Ball Ground, GA (US)

(21) Appl. No.: 18/139,690

(22) Filed: Apr. 26, 2023

Related U.S. Application Data
(63) Continuation-in-part of application No. 15/829,976, filed on Dec. 3, 2017.
Application No. 15/829,976 is a continuation-in-part of application No. 14/790,712, filed on Jul. 2, 2015, now Pat. No. 9,836,763.
Application No. 14/790,712 is a continuation-in-part of application No. 13/667,711, filed on Nov. 2, 2012, now Pat. No. 9,076,161.
(60) Provisional application No. 61/555,842, filed on Nov. 4, 2011.

(51) Int. Cl. G06Q 30/0273; G06Q 30/0241

(52) U.S. Cl. CPC G06Q 30/0273; G06Q 30/0277; G06Q 2220/00

(57) ABSTRACT

Systems and methods are provided for managing advertisements in a network. According to one implementation, a system includes a processing device and a memory device configured to store a computer program having instructions that, when executed, enable the processing device to perform certain functions. For example, the processing devices may be configured to receive planned advertisement input from a remote user device associated with an advertiser. The planned advertisement input may include textual and/or graphical elements of an ad in electronic form. The planned advertisement input may further include a request for the ad to be displayed on one or more media devices. The processing device may also be configured to store the ad using one or more blockchain technologies to create a secured ad and then distribute the secured ad to the one or more media devices based on the request.

### CROSS-REFERENCE TO RELATED APPLICATIONS

This application is a continuation-in-part of U.S. patent application Ser. No. 15/829,976, filed Dec. 3, 2017, entitled “Creating an Advertisement Strategy,” which is a continuation-in-part of U.S. patent application Ser. No. 14/790,712, filed Jul. 2, 2015, entitled “Printing, Displaying, and Etching Advertisements on Various Media,” now U.S. Pat. No. 9,836,763, which is a continuation-in-part of U.S. patent application Ser. No. 13/667,711, filed Nov. 2, 2012, entitled “System for Printing an Advertisement on a Ticket,” now U.S. Pat. No. 9,076,161, which claims the benefit under 35 U.S.C. § 119 of U.S. Provisional Application No. 61/555,842, filed on Nov. 4, 2011, wherein the entire disclosure of each related application is incorporated by reference herein.

### TECHNICAL FIELD

The present disclosure generally relates to advertising, and more particularly relates to systems and methods for using blockchain to secure, organize, track, and distribute advertisements in a distributed system, centralized system, and/or decentralized system.

### BACKGROUND

For years, businesses have created advertisements to endorse their products, brands, etc. Normally, these advertisements can be presented to an audience in a number of ways. For example, some advertisements may be presented in printed form and published in newspapers, magazines, flyers, etc. Other advertisements may be presented in audible form, such as those communicated over the radio. Still others may include both visual and audible elements, such as those that are commonly presented on television or on a computer. Regarding printed advertisements, some businesses, such as restaurants, may choose to advertise by printing coupons. These coupons can be combined with other coupons from other businesses in coupon books, printed in newspapers and magazines, or printed on individual cards or flyers. Despite the numerous ways that a business may advertise, businesses are continually looking for new ways to distribute advertisements and coupons to their audience.

Also, businesses usually attempt to present their advertisements in a way that will reach the type of audience that they intend to target. For example, businesses may wish to purchase television advertisement slots to show commercials to an audience that may be more likely to buy their products or patronize their establishments. The advertisements can then more sharply focus on viewers who might have more of a tendency to watch the associated television programs. This can be done to expose the intended audience to their advertisements. It would be desirable for a business, however, to have greater flexibility in advertising to be able to target their audience so that advertisements can reach the people that may be more likely to use their products or visit their establishments.

### BRIEF SUMMARY

The present disclosure describes various implementations of systems and methods for enabling advertisers to remotely create advertisements for display on ticket printing devices, mobile phones, and other types of media devices. The transmission of advertisement information can be secured and managed using blockchain technologies. Also, systems and methods are described for monitoring the distribution of advertisements and determining the number of times the ads are displayed, which can then be used to calculate a fee to be charged to the advertisers. In addition, the advertisers can target audiences based on time parameters, location parameters, current events, and other conditions.

Systems and methods are provided for securing an advertisement for distribution throughout a network. Methods may be performed by servers or systems having one or more processing devices in addition to memory or non-transitory computer-readable media for storing computer logic. The computer logic may include instructions for enabling the one or more processing devices to perform certain security functions. For example, in one implementation, a first method may include the step of receiving planned advertisement input from a remote user device associated with an advertiser. The planned advertisement input, for example, may include textual and/or graphical elements of an ad in electronic form. Also, the planned advertisement input may further include a request for the ad to be displayed on one or more media devices. The first method may also include the step of storing the ad using one or more blockchain technologies to create a secured ad. Also, the first method includes distributing the secured ad to the one or more media devices based on the request.

In another implementation, a second method may include the step of monitoring an advertisement that is distributed throughout a network and determine a number of times that the advertisement is displayed on one or more media devices in communication with the network. Based on the number of times that the advertisement is displayed, the method further includes calculating a fee to be charged to an advertiser. The method also includes storing the calculated fee with the advertisement using one or more blockchain technologies.

In yet another implementation, systems and methods are provided for displaying advertisements, secured by blockchain, according to certain time parameters. A third method may include a step of obtaining advertisement information that includes visual elements of an advertisement and time parameters defining a range of times when the advertisement is planned to be displayed. The method also includes the step of encrypting the advertisement using one or more blockchain technologies. Also, the method includes the step of distributing the encrypted advertisement to one or more remote media devices to allow the one or more remote media devices to display the advertisement according to the time parameters.

Systems and methods for providing advertisements to targeted audiences are also described in the present disclosure. In another implementation, a method includes the step of obtaining a plurality of advertisement information sets from one or more remote devices associated with one or more advertisers. The advertisement information sets may include advertisements in electronic form, where each advertisement has one or more identifiable classifications for advertising a specific product or service. The method also includes the step of selecting one of the advertisements based on a correlation between one or more observable conditions and the one or more identifiable classifications.

### BRIEF DESCRIPTION OF THE DRAWINGS

The features illustrated in the following figures are intended to emphasize the general principles of the present disclosure and are not necessarily drawn to scale. Consistent reference characters are used throughout the figures to designate corresponding features.

FIG. 1 is a block diagram showing a conventional ticket distribution system.

FIGS. 2A-2D are block diagrams showing advertisement systems according to various implementations of the present disclosure.

FIGS. 3A and 3B are block diagrams showing still more advertisement systems according to various implementations of the present disclosure.

FIG. 4 is a block diagram of an advertisement managing system according to various implementations of the present disclosure.

FIG. 5 is a block diagram of the advertisement planning device shown in FIG. 4, according to various implementations of the present disclosure.

FIG. 6 is a block diagram of the advertisement verification device shown in FIG. 4, according to various implementations of the present disclosure.

FIG. 7 is a block diagram illustrating a ticket managing server, according to various implementations of the present disclosure.

FIG. 8 is a block diagram illustrating a ticket printing device, according to various implementations of the present disclosure.

FIG. 9 is a block diagram illustrating an advertisement system, according to various implementations of the present disclosure.

FIG. 10 is a block diagram illustrating an advertisement system, according to various implementations of the present disclosure.

FIG. 11 is a flow diagram illustrating a method for securing an advertisement for distribution throughout a network, according to various implementations of the present disclosure.

FIG. 12 is a flow diagram illustrating a method for securing an advertisement for distribution throughout a network, according to various implementations of the present disclosure.

FIG. 13 is a flow diagram illustrating a method for displaying advertisements, secured by blockchain, according to certain time parameters, according to various implementations of the present disclosure.

FIG. 14 is a flow diagram illustrating a method for providing advertisements to targeted audiences, according to various implementations of the present disclosure.

### DETAILED DESCRIPTION

The present disclosure describes systems and methods for creating an advertisement strategy, which may include not only the advertisement itself, but also time and location information for specifying when and where the advertisement is to be run. However, rather than using conventional means of presenting an advertisement to an audience, the advertisements according to various implementations of the present disclosure may be printed on various types of media, displayed on various types of electronic devices, transmitted over a public and/or private network, and/or broadcast over wireless communication channels. With the embodiments of the present disclosure, an advertiser or advertiser's representative can easily create and/or upload an advertisement to an advertisement server disclosed herein. Approved advertisements can be immediately printed, displayed, and/or broadcast to a selected audience without additional intermediate steps typically involved in the field of advertising.

### Printing Advertisements on Tickets

For example, advertisements may be printed on any suitable type of ticket, such as a movie ticket, sporting event ticket, concert ticket, theater ticket, lottery ticket, rapid transit ticket, train ticket, airline ticket, or ticket for other events or purposes. When the ticket is related to a particular event happening at a particular time and at a particular place, the advertisement can be customized or altered to exploit these details. In particular, the implementations disclosed herein may be combined with a lottery system, whereas an advertisement can be printed on a lottery ticket that is distributed to a person purchasing the lottery ticket. In particular, lottery tickets (and other types of tickets) represent a unique purchase in that they are printed for an individual at a known location and time. Unlike coupons that might normally get thrown away or ignored, the ticket (e.g., lottery ticket, transit ticket, sporting event ticket, etc.) is usually carefully held unto by the purchaser and looked at and read multiple times during the relatively short lifespan of the ticket.

Using the implementations described in the present disclosure, an advertiser can create one or more advertisement strategies using a process involving online systems. The advertisements can then be distributed to ticket printing devices to be printed for individuals who wish to purchase some type of ticket. The regular ticket information is printed on the ticket along with the advertisement, and the ticket can be handed to the customer. With the example of lottery tickets, the advertisement can be printed on the same ticket that includes the lottery numbers. By allowing the advertisers to choose where the advertisements are printed, the advertisements can be distributed to people who might live or work in a specific area (e.g., near a particular restaurant). For example, lottery ticket printing devices, sometimes referred to as point-of-sale (POS) lottery machines, are usually housed in known, fixed locations, such as in convenience stores, gas stations, grocery stores, restaurants, bars, and other venues.

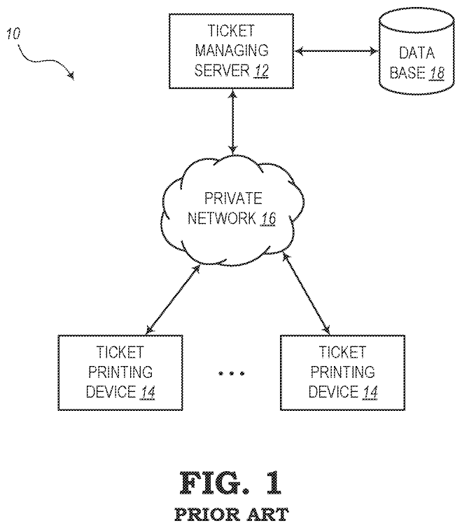

FIG. 1 is a block diagram illustrating a conventional ticket distribution system 10. As shown, the ticket distribution system 10 includes a ticket managing server 12 and a plurality of ticket printing devices 14, where the ticket managing server 12 communicates with the ticket printing devices 14 via a private network 16. The ticket managing server 12 may store ticket information in a database 18. In some embodiments, the ticket printing devices 14 do not communicate with each other, but only communicate with the ticket managing server 12. The ticket distribution system 10 may be a closed system that would normally not operate over the Internet. For security purposes, the private network 16 is normally inaccessible to devices outside the ticket distribution system 10.

In some embodiments, the ticket distribution system 10 is a lottery system that manages and controls the distribution and printing of lottery tickets. The ticket managing server 12 may include one or more computers for a state lottery system or may be the main computer(s) for a lottery system that extends into multiple states, such as the Mega Millions and Power Ball lottery systems. The ticket printing devices 14 may represent the point-of sale (POS) lottery machines where a customer can purchase a lottery ticket. In other embodiments, the ticket distribution system 10 may be related to a system for distributing and printing other types of tickets, such as movie tickets, concert tickets, airline tickets, etc.

When a customer wishes to purchase a lottery ticket (e.g., a ticket for Mega Millions, Power Ball, Daily Double, Pick 3, Pick 4, Win For Life, or other lottery game), the ticket printing device 14 prints out the lottery ticket with a certain number of lottery numbers. These lottery numbers may be selected by the customer or may be randomly selected. When random numbers are selected, the ticket distribution system 10 may include two different scenarios for picking the random numbers. In one embodiment, the ticket managing server 12 may be informed by a particular ticket printing device 14 that numbers are to be selected and will then pick random numbers (e.g., using a random number generator) and supply these numbers to the particular ticket printing device 14. In another embodiment, the ticket printing device 14 itself may be configured to randomly pick numbers if the device is equipped with a random number generator. Once the numbers are picked, the ticket printing device 14 can print the lottery ticket.

When the ticket printing device 14 selects the random numbers (or if the numbers are selected by the customer), the lottery numbers are communicated to the ticket managing server 12 in order that the ticket managing server 12 can store information about the lottery ticket sold, such as the lottery numbers on the ticket, the time and date when the ticket was sold, and the location where the ticket was sold (i.e., an establishment that houses the ticket printing device 14). If the ticket managing server 12 picks the random numbers, the ticket managing server 12 stores the same information about the lottery ticket sold (i.e., the lottery numbers, time, date, and location information). This information can be stored in the database 18.

According to some reports, the sale of lottery tickets in the United States exceeded $50 billion in 2011, which is about $200 per capita. Also, there were over 200,000 lottery ticket printing devices 14 operating in the U.S. in 2011, and the number of devices continues to rise. From this information, it can be determined that a typical ticket printing device 14 may print over 200,000 tickets per year, or more than about 20 per hour.

### Advertisement Systems

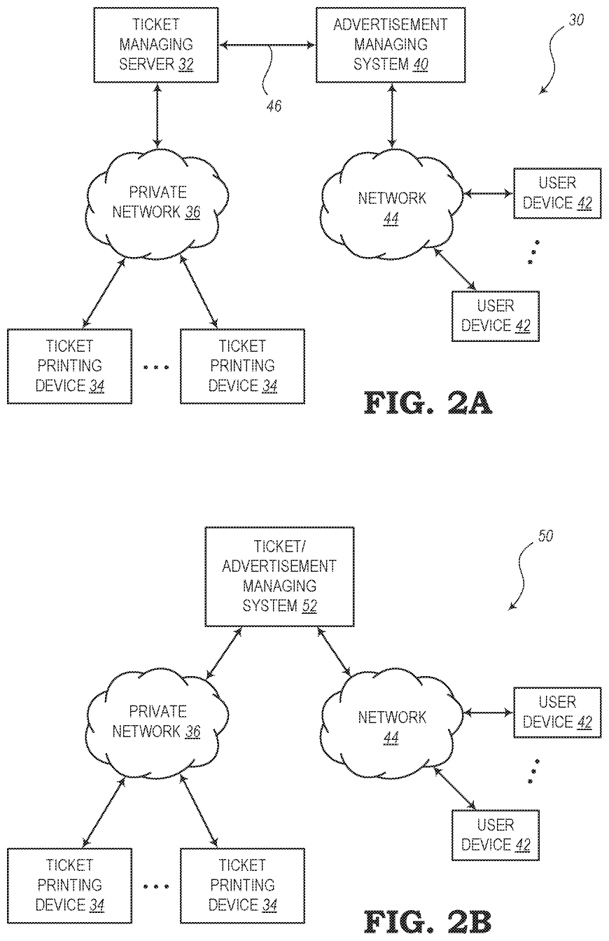

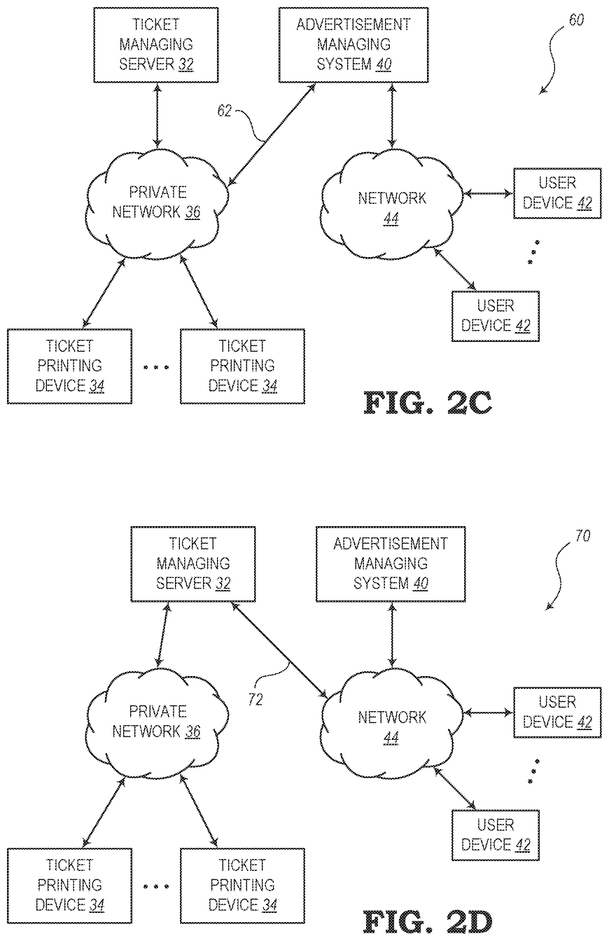

FIGS. 2A through 2D are block diagrams illustrating various embodiments of advertisement systems according to various implementations of the present disclosure. The advertisement systems of FIGS. 2A-2D include advertisement distribution systems combined with ticket distribution systems. The advertisement distribution systems can be incorporated with any type of ticket distribution system that includes printing facilities located in specific locations where an advertisement can be printed on any suitable medium. In some embodiments, the ticket distribution systems are lottery systems. The ticket printing devices 34 in these embodiments may be configured to print any type of tickets, depending on the type of system in which they are deployed. For example, in a sporting event ticket printing system, the ticket printing devices 34 may be configured to print tickets for various sporting events. The printed tickets may include lottery tickets, movie tickets, concert tickets, sporting event tickets, rapid transit tickets, airline tickets, or other types of tickets. In some embodiments, the ticket printing devices 34 may alternatively be configured to print other types of items (e.g., pamphlets, brochures, flyers, newspapers, magazines, etc.).

The advertisement systems of FIGS. 2A-2D may represent systems or servers that are configured for a single state (e.g., Georgia), multiple states, a country, multiple countries, or other geographical or political regions. For example, when configured with a lottery system, one advertisement system may be located in each state, and communication may take place between systems of other states, particularly for interstate lottery games (e.g., Mega Millions, Power Ball, etc.).

It should be noted that each advertisement system of FIGS. 2A-2D may include security measures that are incorporated throughout the respective system. Thus, when an advertisement is created, security elements are added. Also, when advertisements are distributed to the ticket printing devices 34, the security elements can be verified to ensure that the advertisements are authentic. Furthermore, when an advertisement is printed, the ticket printing devices 34 may also check the security elements. The security elements may include encoding/decoding protocols, encryption/decryption protocols, or other protocols that are known by some or all of the components (e.g., the ticket managing server 32, ticket printing devices 34, and advertisement managing system 40) of the systems of FIG. 2. In some embodiments, the components of the systems may utilize code characters, passwords, or other codes that are configured to change in a certain way. For example, a code number may increase by a certain value on a regular basis (e.g., every day). Also, the components of the systems may be configured to use and check for certain advertisement characteristics to ensure security. For example, these advertisement characteristics may include a specific size of an image of the advertisement, a specific type of file, a file naming convention, a specific number of dots per inch (dpi) for the advertisements, or other characteristics.

The advertisement systems of FIGS. 2A-2D may allow an advertiser to promote local events, drive business to a particular store, promote brand affinity with local organizations (e.g., local sports teams), promote special events (e.g., sporting events, fairs, festivals, etc.), and even raise money for charity. The advertisement systems allow advertisers to easily target specific areas. Also, advertisers can run advertisements at specific times, depending on local events or other occurrences that may have a limited duration (e.g., a fair or circus in a local area, etc.).

As opposed to a system that includes an advertisement for one advertiser that is printed on all tickets in a batch, the advertisement systems of the present disclosure enable multiple advertisers to advertise as many advertisements as they wish and have the advertisements targeted at only certain locations. In this regard, the present disclosure provides a variable system that can select from among a plurality of advertisements, depending on various parameters. Also, the advertisements can be printed on a ticket, as opposed to other media, which may normally be maintained more carefully by its holder than a typical coupon. Therefore, it may be more likely that the holder will view the advertisement more often.

FIG. 2A shows an embodiment of an advertisement system 30. In this embodiment, the advertisement system 30 includes a ticket managing server 32, ticket printing devices 34, a private network 36 interconnecting the ticket managing server 32 with the ticket printing devices 34, an advertisement managing system 40, user devices 42, and a second network 44 interconnecting the advertisement managing system 40 with the user devices 42. Although not shown, the ticket printing devices 34 may, according to some implementations, be connected to the network 44. As shown, the private network 36 and second network 44 are separate from each other. The network 44 may be a public network, a private network, the Internet, a blockchain-based network, and/or other suitable types of communication networks.

The advertisement system 30 may be incorporated into an already existing ticket distribution system that includes, for example, the ticket managing server 32, ticket printing devices 34, and private network 36. These elements may be similar to the corresponding elements shown in FIG. 1. However, according to the embodiments described in the present disclosure, the ticket distribution system portion of the advertisement system 30 not only prints tickets and records information about the tickets, but also may be configured to alter the tickets, such as by creating a space or place holder that allows one or more advertisements to also be printed on the ticket. Advertisements that are created by the advertisement managing system 40 may be stored in a database or other memory device. According to various embodiments, one or more databases or memory devices may be connected to the ticket managing server 32, the advertisement managing system 40, and/or the ticket printing devices 34. Then, when a ticket is to be printed, an advertisement is retrieved from the database and printed along with the ticket information.

Regarding the aspect of creating an advertisement or planning an advertisement strategy, the advertisement system 30 uses the advertisement managing system 40. The advertisement managing system 40 is configured to communicate with one or more user devices 42 via the network 44. According to some embodiments, the network 44 may be a local area network (LAN) and/or a wide area network (WAN), such as the Internet. The network 44 may include wired and/or wireless components. In some embodiments, the network 44 may be omitted altogether such that communication between the user devices 42 and the advertisement managing system 40 involves physically delivering a data storage device (e.g., CD, flash drive, or other portable storage device) from one device to the other.

When the network 44 is configured for local communication, the user devices 42 may represent terminals used by people who are associated with the advertisement managing system 40 for inputting advertisement orders for various clients. In other embodiments, the user devices 42 may represent computers or other processing devices connected to the advertisement managing system 40 via the Internet, where these user devices 42 are used by advertisers who wish to create an advertisement online. In this respect, the advertisement managing system 40 may include a web server for providing a website where users can create one or more advertisements and/or plan advertisement strategies or campaigns.

The ticket distribution portion and advertisement portion are combined in the embodiment of FIG. 2A by a bridge 46, which may include a permanent or removable conductor connecting the ticket managing server 32 with the advertisement managing system 40. The bridge 46 may include USB connections, a dedicated conductor, a Secure Shell (SSH) connection, or other suitable connectivity between the various servers. The servers may be synchronized using an SSH protocol. In some embodiments, the bridge 46 may be replaced with an indirect connection, such as providing information on a memory device (e.g., CD, flash drive, etc.) and physically transferring information from one device to the other. In some embodiments, the ticket managing server 32 and advertisement managing system 40 may communicate using a third network on which only these two systems communicate.

Regardless of the manner in which the devices are connected, the advertisement managing system 40 communicates advertisements and associated information to the ticket managing server 32 to enable printing of the advertisements on tickets according to specific instructions. Also, the ticket managing server 32 communicates information back to the advertisement managing system 40 providing verification that all or some of the advertisements to be printed have indeed been printed. The verification information may include advertisement information (which advertisement(s) were printed), the time and date when the advertisement(s) were printed on the tickets, when the ticket was handed to a customer, and the locations where the advertisement(s) were printed. Ticket information does not normally need to be supplied to the advertisement portion of the advertisement system 30. Therefore, the bridge 46 may provide secure communication and may prevent the user devices 42 or other components of the advertising portion of the system 30 from communicating with or hacking into the ticket managing server 32.

Communication between the ticket distribution portion of the advertisement system 30 and the advertisement portion of the advertisement system 30 may be made on a limited basis. For example, advertisements may be communicated to the ticket portion on an hourly basis, daily basis, weekly basis, or other suitable time intervals. Also, confirmation of the printing of advertisements may be communicated back to the advertisement portion on an hourly basis, daily basis, weekly basis, or according to other suitable or programmable periods. It should be noted that some or all of the features described herein with respect to FIG. 2A may also be applicable to FIGS. 2B-2D as well.

FIG. 2B is a second embodiment of an advertisement system 50. The advertisement system 50 in this embodiment is similar to the system 30 of FIG. 2A, except that the ticket managing server 32 and advertisement managing system 40 are combined into one server or computer system, labeled as a ticket/advertisement managing system 52. In some embodiments, the ticket managing server 32 shown in FIG. 2A may be modified to include the features of the advertisement managing system 40 to provide the ticket/advertisement managing system 52. The modified ticket server in this respect may include a second interface device to allow communication on the second network 44. According to some embodiments, the ticket/advertisement managing system 52 may include a switch (e.g., electrical, mechanical, or electromechanical switch) that enables the system 52 to operate as a ticket managing server at some times and to operate as an advertisement managing system at other times. The switch can also be used to switch between operating over the private network 36 at some times while operating on the second network 44 at other times.

FIG. 2C shows another embodiment of an advertisement system 60. In this embodiment, the bridge 46 shown in FIG. 2A is omitted and instead the advertisement managing system 40 is configured to connect to the private network 36 via a secure connector 62. The secure connector 62 may limit the operations of the advertisement managing system 40 within the private network 36. As such, the advertisement managing system 40 may provide advertisements to the ticket managing server 32 and/or ticket printing devices 34 and receive confirmation from the ticket printing devices 34 or ticket managing server 32 as to when and where the advertisements are printed.

FIG. 2D shows another embodiment of an advertisement system 70. In this embodiment, the bridge 46 shown in FIG. 2A is omitted and instead the ticket managing server 32 is configured to connect to the network 44 via a secure connector 72. The secure connector 72 may limit or restrict the access that the components on the network 44 may have with the ticket managing server 32. The ticket managing server 32 may retrieve advertisements from the advertisement managing system 40 via the network 44 and may provide confirmation information to the advertisement managing system 40, or even directly to the user devices 42. The confirmation information may be designed to confirm which advertisements have been printed, the time and date of printing, and the locations where they were printed.

### Advertisement Systems Over a Common Network

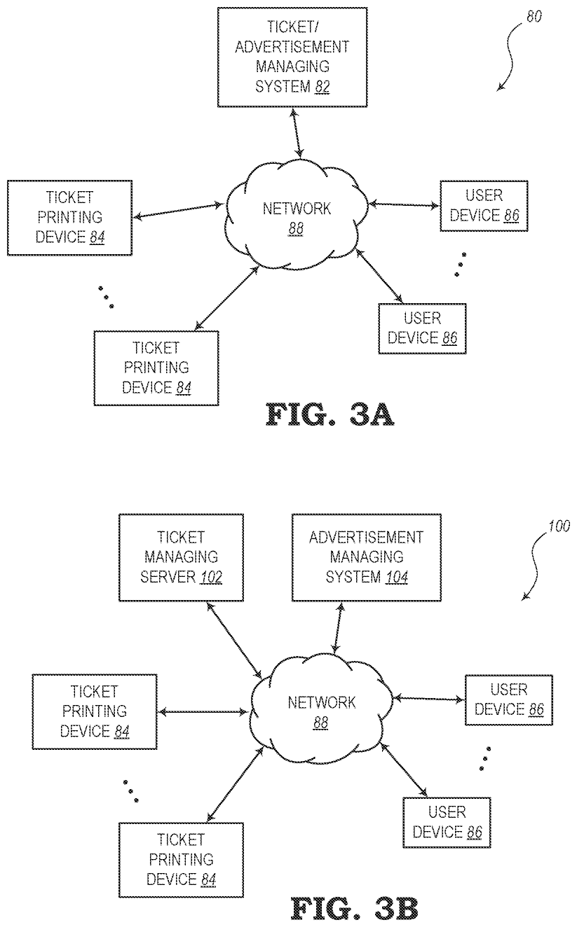

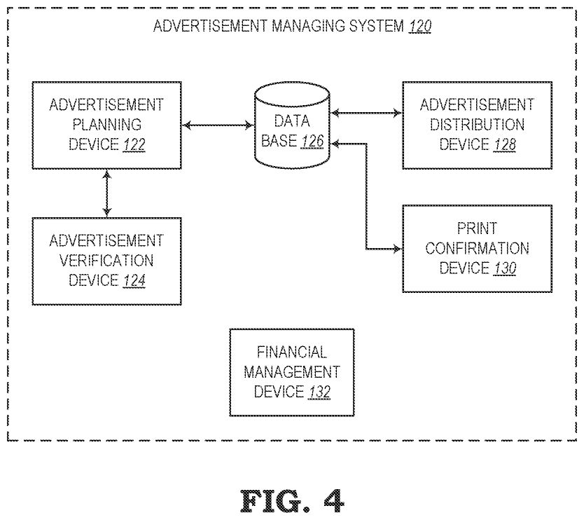

FIGS. 3A and 3B are block diagrams showing other embodiments of advertising systems according to the present disclosure. In these embodiments, in contrast to the embodiments of FIGS. 2A-2D that operate over two separate networks, the ticket distribution portions and advertisement portions exist together and operate over a common network. For example, the network in these embodiments may include a secure network. Since it may be much more expensive to operate on and maintain the private network 36, costs can be reduced by operating on a single network. Therefore, the advertisement systems of FIGS. 3A and 3B, which include both the ticket distribution portion and the advertisement portion, can operate on the Internet or other wide area network, which may be a less expensive alternative and save a large amount of money for the ticket distribution systems or state lottery systems. Additional security measures in this case may be added to prevent unauthorized access to the ticket distribution system (e.g., lottery system) via the Internet.

FIG. 3A shows an embodiment of an advertisement system 80, which includes a ticket/advertisement managing system 82, a plurality of ticket printing devices 84, and a plurality of user devices 86, interconnected by way of a network 88. The network 88 may include the Internet and may also include local or other wide area networks. In this embodiment, the ticket/advertisement managing system 82 communicates with the ticket printing devices 84 via the network 88. The ticket/advertisement managing system 82 in this embodiment may be configured to perform the ticket distribution functions and perform the advertisement functions as described in the present disclosure.

In some embodiments, the ticket/advertisement managing system 82 may be configured to communicate with the user devices 86 in a limited capacity. The user devices 86 may be used as mentioned above to create or plan an advertisement strategy. The user devices 86 may access the ticket/advertisement managing system 82 to perform the advertisement functions.

Information regarding the advertisement strategies that are created by the ticket/advertisement managing system 82 is configured to combine the advertisements, according to the advertisement strategies, with the ticket information (e.g., lottery numbers). The advertisement information and ticket information may be stored on separate databases or in the same database. The ticket/advertisement managing system 82 instructs the respective ticket printing devices 84 that when a ticket is to be printed, it is printed with the combination of a selected advertisement and ticket information on the ticket. The ticket/advertisement managing system 82 may also provide information about printed advertisements to the specific user devices 86 to inform the respective advertisers or agents associated with advertisers of the results of the advertisement strategies.

FIG. 3B is a block diagram of another advertisement system 100, which is similar to FIG. 3A. In this embodiment, however, the ticket managing server 102 and advertisement managing system 104 are individually configured as separate components on the network 88. In this way, it may be easier to separate the ticket distribution functions from the advertisement functions. Also, the ticket managing server 102 may be specifically configured to limit or restrict access by the user devices 86.

According to additional embodiments with respect to the present disclosure, the embodiments of FIGS. 2A-2D, 3A, and 3B may further include means for issuing mobile tickets, such as mobile lottery tickets or other types of mobile tickets. For example, in place of the ticket printing devices 34 and 84, a transmitter or wireless communication device may be employed using any suitable wireless protocol. The wireless communication device in this case may be configured to conduct the sale of virtual tickets to users of mobile devices (e.g., mobile phones, smart phones, tablets, laptop computers, or other mobile devices) and receive a fee for the sale of the virtual ticket.

In addition to ticket information that might normally be displayed on a display screen of the mobile device, the virtual tickets may also include an area for an advertisement. Therefore, when the ticket information is displayed, the advertisement may also be displayed on the same screen whenever the virtual ticket is shown. In some embodiments, the advertisement may be displayed on the screen independently of the display of the ticket information. For example, the advertisement may be flashed on the screen when the virtual ticket is first purchased or may be displayed at random or predetermined times after purchase.

Advertisements using the mobile device may allow the particular establishment to offer a unique advertisement to mobile device users. For example, in a restaurant environment, if a customer purchases a ticket (e.g., virtual lottery ticket), the same restaurant may utilize the advertisement systems of the present disclosure to send an ad to the customer while the customer is still on the premises. The advertisement in this case may include an instruction for the customer to “Call your waitress to find out about getting a dessert for half off” or some other type of message.

In addition to using mobile devices for receiving a virtual ticket, mobile devices may also be used in place of the user device 42, 86. Thus, the mobile device can communicate with the advertisement portion of the advertisement systems of FIGS. 2 and 3. Particularly, a user may wish to access the advertisement managing system 40, 104 via the network 44, 88 using the mobile device. In this example, the network 44, 88 may be configured to include cellular communication, Wi-Fi, or other wireless protocols. In this respect, the user may be enabled to create an advertisement and advertisement strategy using a smart phone or other mobile device. Using the mobile device, a user can also edit an advertisement, turn on an advertisement, turn off an advertisement using the user's own discretion.

### Advertisement Managing System

FIG. 4 is a block diagram illustrating an embodiment of an advertisement managing system 120. For example, the advertisement managing system 120 may represent any one or more of the advertisement managing systems 40, 104 and/or ticket/advertisement managing systems 52, 82 described above with respect to FIGS. 2 and 3. For the sake of clarity, when the advertisement managing system 120 represents any one or more of the ticket/advertisement managing systems 52, 82, it should be noted that the portions of the system that relate to ticket management functions have been omitted. In some embodiments, some or all of the components of the advertisement managing system 120 may be incorporated in any one or more of the ticket managing servers 32, 102 described above with respect to FIGS. 2 and 3.

As shown in FIG. 4, the advertisement managing system 120 includes an advertisement planning device 122, an advertisement verification device 124, a database 126, an advertisement distribution device 128, a print confirmation device 130, and a financial management device 132. The components of the advertisement managing system 120 may be configured in a single computer or may be configured in multiple computer systems and interconnected by a suitable network or bus interface. The computer(s) may include one or more processing devices, such as general-purpose or specific purpose processors or microcontrollers for controlling the operations and functions of the advertisement managing system 120.

The computer(s) may also include one or more memory devices, which may be configured as internally fixed storage units, removable storage units, and/or remotely accessible storage units, each including a tangible, non-transitory storage medium. The various storage units may include any combination of volatile memory (e.g., random access memory (RAM), dynamic RAM (DRAM), etc.) and non-volatile memory (e.g., read only memory (ROM), electrically erasable programmable ROM (EEPROM), flash memory, etc.). The storage units may be configured to store any combination of information, data, instructions, software code, etc.

In some embodiments, the components of the advertisement managing system 120 may be implemented in hardware, software, firmware, or any combinations thereof. For example, portions of the advertisement managing system 120 that are implemented in software or firmware may be stored on a non-transitory memory device, such as a computer-readable media device, and may be executable by a suitable instruction execution system, such as a processing device. The portions implemented in hardware may include discrete logic circuitry, an application specific integrated circuit (ASIC), a programmable gate array (PGA), a field programmable gate array (FPGA), or any combinations thereof.

The functions, operations, and/or programs executed by the advertisement managing system 120 may comprise an ordered listing of executable instructions for implementing logical functions and can be embodied in any non-transitory computer-readable medium for use by an instruction execution system or device, such as a computer-based system, processor-controlled system, etc. In the context of the present disclosure, a computer-readable medium can be any medium that can contain, store, communicate, propagate, or transport programs for execution by the instruction execution system or device. Examples of computer-readable media may include electronic, magnetic, electromagnetic, optical, infrared, or other systems or devices.

As described in more detail below, the advertisement planning device 122 shown in FIG. 4 may be configured with the network 44, 88 and one or more user devices 42, 86 to enable a user associated with the user device 42, 86 to create an advertisement strategy. The advertisement strategy, for example, may include electronically arranged elements of an advertisement, a time period when the advertisement is to be run, and one or more predetermined locations where the advertisement is to be run. The user device 42, 86 is configured to communicate with the advertisement planning device 122 via the network 44, 88 to enable the user to create the advertisement strategy.

The advertisement managing system 120 further comprises the advertisement verification device 124, which may be in direct communication with the advertisement planning device 122. The advertisement verification device 124 is configured to automatically check for obscene or vulgar content in the advertisement. If any such content is found, the advertisement can be rejected. The automatic check may be performed by searching for profanity, certain obscene, vulgar, indecent, or morally questionable language in the text portions of the advertisement. The advertisement verification device 124 may also be configured to allow a person, such as an advertisement verifier, to visually check the content of the advertisement. This check may allow the person to prevent inappropriate content from being placed in the advertisements that might be displayed on the lottery ticket. For example, the visual check may include searching images and text for inappropriate content.

When an advertisement is created and verified, an advertisement strategy can also be created. The advertisement strategy may include, for example, the actual advertisement content (e.g., images and text), run times when the advertisement is to be revealed, and one or more locations where the advertisement is to be revealed. When completed, the advertisement strategies are stored in the database 126. The advertisement distribution device 128 accessed the database 126 in a controlled manner to retrieve advertisements from the database 126 and distribute them according to the time and location information. It may be preferable that advertisements to be revealed during a certain time period are bundled together and distributed to the ticket managing server 32 or individual ticket printing devices 34 before the actual run time so that the advertisements can be revealed at the proper times.

The print confirmation device 130 tracks the advertisements to confirm that the advertisements have been printed according to their associated time and location parameters. Also, if one or more of the ticket printing devices 34, 84 is saturated with advertisements, or, in other words, has more advertisements to print during a certain time period than actual lottery tickets that were printed during that time period, the print confirmation device 130 tracks how many of each of the advertisements were actually printed. The print confirmation device 130 may track information for the actual advertisements printed, the times and dates when they were printed, and the ticket printing devices 34, 84 that printed the advertisements (or establishment where the respective ticket printing device is located). The tracking information may be submitted to the financial management device 132 to calculate how much an advertiser might pay for the advertisements that were actually printed. The financial management device 132 may also be configured to charge an advertiser a certain fee, such as about $5.00, to submit an ad for confirmation, which will be checked by the advertisement verification device 124. The reason for charging this fee is that a person would normally be required to actually perform the visual confirmation of the ad. However, an additional fee would not be required if an ad is reused, as long as it is not edited to such an extent that another confirmation check is needed.

The advertisement planning device 122 may be further configured to introduce security elements to the advertisement strategies that are stored. These security elements can be used throughout the system to ensure that the advertisement information is communicated securely. The security elements are designed to prevent hackers from accessing the advertisements and introducing unauthorized content into the ads. The security elements also prevent other types of unfavorable intrusion into the system. The security elements may be added to the advertisement strategy information, filenames assigned to the advertisement strategies, or other files associated with the advertisement strategies.

### Advertisement Planning Device

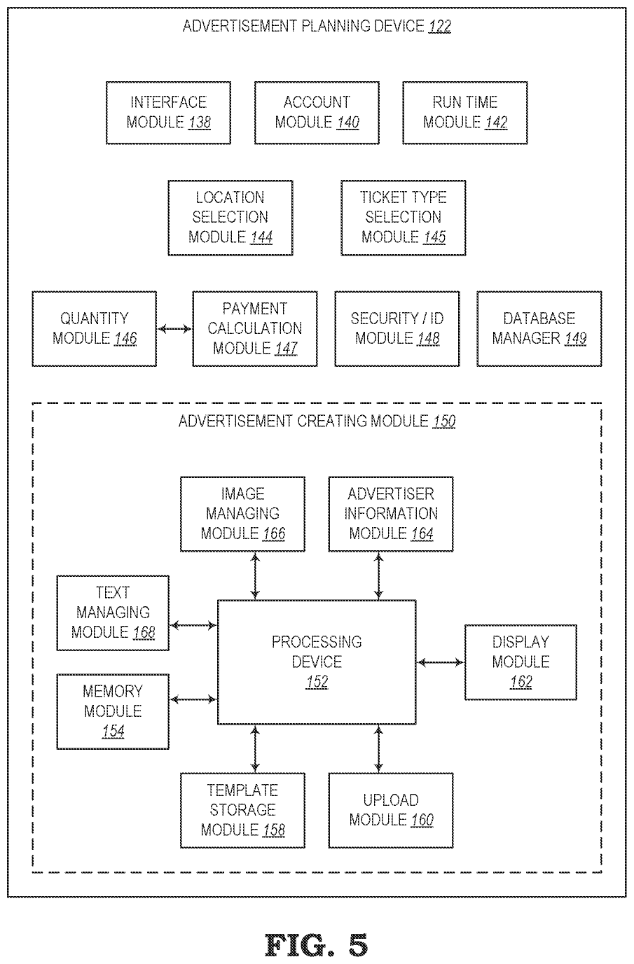

FIG. 5 is a block diagram showing an embodiment of the advertisement planning device 122 shown in FIG. 4. As mentioned above, the advertisement planning device 122 is configured to enable a user (e.g., an advertiser) to create an advertisement strategy. In some embodiments, the advertisement planning device 122 may be a web-based portal that allows the user to create the advertisement strategy online using a remote computer. The advertisement planning device 122 allows multiple users to create a plurality of advertisement strategies that can be distributed and run on multiple ticket printing devices.

According to various embodiments, the advertisement planning device 122 includes an interface module 138, an account module 140, a run time module 142, a location selection module 144, a ticket type selection module 145, a quantity module 146, a payment calculation module 147, a security/identification module 148, a database manager 149, and an advertisement creating module 150. The advertisement creating module 150 may include, according to the illustrated embodiment, a processing device 152, a memory module 154, a template storage module 158, an upload module 160, a display module 162, an advertiser information module 164, an image managing module 166, and a text managing module 168.

The interface module 138 is configured to enable a user device 42 associated with a user (e.g., an advertiser) to communicate with the advertisement planning device 122 via a network 44, 88. In this way, the user may utilize the advertisement planning device 122 to create an advertisement and plan an advertisement strategy.

The account module 140 allows a user to create an account for an advertiser. The user logs in to an established account whenever the user wishes to create and/or edit one or more advertisement strategies, which may also be referred to as an advertisement campaign. As mentioned above, the advertisement strategy includes not only an advertisement, but also a time period when the advertisement is to be run and one or more locations where the advertisement is to be run. The advertisement strategy may also include a quantity value that represents a maximum number of advertisements to be revealed. The act of revealing the advertisement, as mentioned above, may include the printing of the advertisement on, for example, a lottery ticket. The account module 140 may also be configured to receive advertiser information, such as a physical billing address, information regarding a contact person or manager, e-mail information, billing information, contact information, and other information.

The run time module 142 enables a user to enter run time information. For example, the run time module 142 may allow the user to enter a time period as short as one hour (e.g., from 5:00 to 6:00 pm on a particular Friday), to run indefinitely, or any other suitable time period. The run times may be entered as a start time and an end time. In some embodiments, the run times may include entry of specific times every week (e.g., from 1:00 to 6:00 pm every Thursday and Friday). Therefore, the user may select specific days and/or hours when the ads are run.

The location selection module 144 allows a user to select one or more specific locations where the advertisements are to be printed. Using the location selection module 144, the user can select a nationwide target (e.g., every ticket printing device 34, 84 in the United States), a statewide target (e.g., every ticket printing device 34, 84 in the state of Georgia), a citywide scope, countywide scope, zip code scope, or any other definable scope or target. Also, the location selection module 144 may allow the user to select the ticket printing devices 34, 84 within a certain distance from a certain point. For example, the user may wish to select locations for printing the advertisements at the locations of the ticket printing devices that are within a certain distance from the advertiser's store(s). As an example, a local pizza restaurant may wish to target printing locations that are within 5 miles of its building. In another example, a business may own several stores or a chain of stores and may wish to target the printing locations within a certain distance from each of those stores. In some embodiments, the location selection module 144 may provide an interactive map that the user can access to select specific printing locations. Printing locations may be selected in groups, individually, a combination of groups and individually, or any other manner. Selecting locations may also involve performing a search for locations in a certain area and selecting one or more printing locations from the search results.

The ticket type selection module 145 is configured to allow the user to select which type or types of tickets the advertisements are to run on. For example, in a movie ticket system, the user can pick one or more movies (e.g., The Avengers, Thor, Iron Man 3, etc.). The advertisements will be scheduled to be printed on the tickets for those selected movie(s). Also, in the example of the lottery system, the user can select the type of lottery game (e.g., Pick 3, Pick 4, etc.), and the advertisement will be scheduled to be printed on the tickets for those selected game(s). The ticket type selection module 145 also allows the user to select other types of details, depending on the type of ticket, specifics of those tickets, and other factors.

The advertisement planning device 122 also has a quantity module 146, which allows the user to enter a maximum number of times that the advertiser wishes to have the advertisement printed. The quantity module 146 may be in communication with a payment calculation module 147, which is configured to determine the cost of having the advertisement printed the selected number of times. The advertising cost may be variable, depending on a number of factors. For example, certain times of the day may be more desirable and may incur a higher cost, whereas other times may incur a smaller cost. The cost may be based on the quantity of ads requested in the quantity module 146. For instance, if a higher number of ads are requested, the cost per ad may be reduced, whereas printing fewer ads may cost more per ad. Also, different types of businesses may have different advertisement cost scales. As an example, the advertising cost may be about five cents, ten cents, 25 cents, one dollar, five dollars, or other suitable or agreed upon amounts for each advertisement printed. The payment calculation module 147 may include a bidding system that prioritizes the printing of ads based on the highest bidder.

The advertisement creating module 150 includes a processing device 152 that is configured to control its overall functions for creating an advertisement. The advertisement creating module 150 is configured to enable a user to create, upload, modify, and/or select one or more images, logos, etc. into an advertisement to be created. The user can also enter text. The advertisement creating module 150 allows the user to electronically organize elements of an advertisement by manipulating the image and text elements of the advertisement within a designated space in an advertisement window and custom design the way the advertisement may be displayed. The display module 162 may be configured to create the advertisement window for showing the user how the advertisement might appear, where the window may represent the size and shape of the advertisement area on a ticket. The advertisement creating module 150 is configured to enable the user to spatially arrange the elements of the advertisement within an area having a predetermined size and shape.

The user may add images from different sources. A first source is the template storage module 158, which may contain multiple generic images that may be selected. The template storage module 158 may allow the user to select different categories (e.g., restaurants, etc.) and further select sub-categories (e.g., pizza restaurants, etc.) and so on. Regarding the example of a pizza restaurant, the template storage module 158 may store various images of pizzas or slices of pizzas that may be used by the user for creating an advertisement for their pizza restaurant. The template storage module 158 may also include templates of advertisement text or coupons that may be related to the categories, sub-categories, etc. For example, pizza restaurant ad templates may include an advertisement for “$2 off a large pizza,” “Buy one pizza, get a second one free,” etc. These templates can be modified by the image managing module 166 and/or text managing module 168 to some extent.

The advertisement creating module 150 also contains an upload module 160 that allows the user to upload images, logos, trademarks, etc. for the advertiser. With the standard images from the template storage module 158 and the images uploaded with the upload module 160 available in the processing device 152, the user is able to arrange the size and location of the images in the advertisement. The display module 162 may be used to display the advertisement or to process the visual images to show how the ad may look and convey these images to be displayed on the user device 42, 86. At this point, the display module 162 may show what the ad will look like if it were saved and printed, but may simply include code that defines the size and location characteristics. The display module 162 may allow the elements in the ad being created to be moved around the screen. In some embodiments, the display module 162 may include a basket that allows items to be selected and used when needed. The items can be dragged out of the basket and placed wherever the user wishes.

The advertiser information module 164 of the advertisement creating module 150 is configured to enable the user to enter specific advertiser information that may be printed on the advertisement. The advertiser information module 164 may allow entry of the name of the business or advertiser, one or more physical addresses of the businesses, phone numbers for the businesses, or other information. The information about the advertiser may be printed as part of the advertisement so that a ticket purchaser can find and/or contact the business. This information may be more applicable for use with small businesses. For larger businesses, text such as “Valid at participating stores” or other similar messages may be selected.

Other additional text may be entered using the text managing module 168. For example, the text managing module 168 may enable the user to include customized coupon information, quotes, direction information to clarify the location of an establishment, or other text. The text managing module 168 also enables the user to enter other information that can be printed on the advertisement. For example, the user may enter text that defines a special deal or coupon offer, such as “$2.00 off a large pizza”. The user may also enter a textual phrase, such as “Big Bob's Pizza is the Best!”

The memory module 154 is configured to store an advertisement that the user creates using the advertisement creating module 150. The advertisements at this stage may contain images, text, and code that defines the physical arrangement of the images and text within the ad window. When the user has completed the advertisement and wishes to have it verified, the stored advertisement is transmitted from the memory module 154 to the advertisement verification device 124 via the interface module 138. When the advertisement is verified and considered acceptable for printing, the processing device 152 may be configured to combine the various image and text elements and store the ad in a pdf, jpeg, gif, or other file format in the memory module 154. Also, the saved ad can be stored in the database 126 by way of the database manager 149.

When an advertisement strategy is created, the security/identification module 148 is configured to add security elements to the advertisement strategy. An arrangement can be determined beforehand that security will include certain coding/decoding elements, certain encryption/decryption elements, etc. In this way, only the compatible components in the system (i.e., the ticket managing server, advertisement managing system, and ticket printing devices) will recognize and understand what security elements are in place and will be able to process the advertisement strategies without issue. At the same time, the security elements will prevent unauthorized tampering or hacking of the advertisement strategies by external devices.

The security elements added by the security/identification module 148 may include ensuring that the advertisement features include a certain size or dimensions, that the advertisement includes a specific dpi resolution, that the advertisement strategy includes a specific file naming convention, that a password is added that is only recognized by the compatible devices, or other security features. Also, other components of the advertisement systems will understand the security features. A component of the system that receives an advertisement strategy at a later stage can check the MAC address, IP address, computer identification code, computer key, or other identification number of the sending component (e.g., advertisement planning device 122) to determine if is being received from a reliable source. Algorithms can be used to change passwords or number codes on a regular basis in a manner that is known by the other devices. These and other security measures can be taken by the security/identification module 148 to protect the integrity of the advertisement systems.

According to various implementations, the one or more predetermined locations entered by the user correspond to one or more establishments where the advertisement is to be revealed. The location selection module 144 is configured to enable the user to select the one or more predetermined locations on at least one of a nationwide scale, statewide scale, citywide scale, countywide scale, and zip-code scale. The location selection module 144 is also configured to enable the user to select the one or more predetermined locations based on a distance of the one or more predetermined locations from one or more stores associated with an advertiser.

Using the advertisement planning device 122, an advertiser may wish to create an advertisement strategy having a specific ad image, time and location information, etc. Then, the advertiser may also wish to create another advertisement strategy with the same ad image, but with different times and/or locations. With multiple advertisement strategies, the advertiser can customize how the ads are to be distributed. For example, an advertiser may want to advertise more heavily in an area closer to the location of the business. Also, the advertiser may wish to advertise with different ads in different regions to appeal to the interest (e.g., local sports teams) in the respective regions.

Once an advertisement strategy is created by the advertisement creating module 150, the advertisement strategy can be stored in a database (e.g., database 126) using the database manager 149. The database manager 149 may be configured to include additional information to be stored with the advertisement strategy and enter the information in the database in an organized manner.

### Advertisement Verification Device

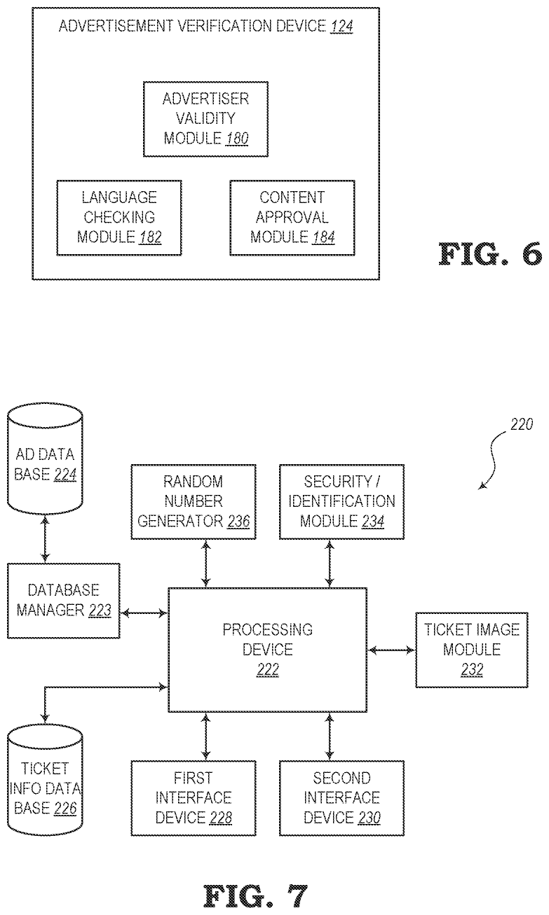

FIG. 6 is a block diagram of an embodiment of the advertisement verification device 124 shown in FIG. 4. The advertisement verification device 124 in this embodiment includes an advertiser validity module 180, a language checking module 182, and a content approval module 184. The advertiser validity module 180 is configured to determine whether the advertiser is a legitimate business. This may be determined by checking with business records for a particular state (e.g., Georgia), such as the Secretary of State records. Also, the advertiser validity module 180 can determine if an address of the business is near the specific addresses where the ads are to be run. If not, then the advertiser validity module 180 may determine that an error has occurred. The advertiser validity module 180 can also run a credit check, check a license to operate, check phone numbers and addresses of the business, or other perform other checks to determine if the entered information for the advertiser is or appears to be valid.

The language checking module 182 is configured to analyze the text that is entered in an advertisement and check it with predetermined words or phrases that may be considered to be offensive, vulgar, obscene, or inappropriate in any way, depending on censorship criteria for a state or state lottery system. For example, a state or state lottery system may determine that certain content, such as those related alcohol, sex, etc., are not permitted in the advertisements and will not be approved for printing. If inappropriate words or phrases are present in the ad, the advertisement verification device 124 informs the user that the advertisement has been rejected. The reasons for rejection may also be provided to the user.

If an advertisement is approved by the language checking module 182, a human reviewer can then check the advertisement. The advertisement may be forwarded to the content approval module 184. In some embodiments, the content approval module 184 may be configured to present the advertisement to the reviewer, who can review the advertisement and check for content (i.e., images, text, etc.) to determine if the advertisement is appropriate according to the specific censorship criteria set by the state or lottery system. The criteria may be different for different states or lottery systems and may require the reviewer to understand the particular censorship guidelines thereof. If the reviewer deems that the advertisement is appropriate for general audiences, the advertisement verification device 124 approves the advertisement for printing and may notify the user that the advertisement can be used. If it is not appropriate, the user is notified that the advertisement has been rejected. In some embodiments, the reviewer may call the advertiser to clear up any issues.

### Ticket Manacling Server

FIG. 7 is a block diagram illustrating an embodiment of a ticket managing server 220. According to some embodiments, the ticket managing server 220 may represent the ticket managing server 32 shown in FIG. 2A, 2C, or 2D, or the ticket managing server 102 shown in FIG. 3B. Also, the ticket managing server 220 may represent all or parts of the ticket/advertisement managing system 52, 82 shown in FIG. 2B and FIG. 3A, respectively.

The ticket managing server 220 may be configured to manage and organize ticket systems in which a number of tickets may be printed, even at multiple locations. The ticket managing server 220 may be used for the printing and/or distribution of various types of tickets, such as tickets for movies, sporting events, concerts, lotteries, metro train transit, bus transit, train transit, or other types. The ticket managing server 220 also controls a printing functionality that allows an advertisement to be printed on the ticket along with the normal ticket information.

Also, according to some embodiments, the ticket managing server 220 may be a lottery server for managing the operations of a lottery system, such as a state-run lottery system. However, according to various implementations of the present disclosure, the ticket managing server 220 may also include additional components that allow the ticket managing server 220 to not only manage lottery functionality, but also to allow advertisements to be printed on lottery tickets.

The ticket managing server 220 may be configured to enable the printing of advertisements based on certain time and location specifications, which may be entered by a user, such as an advertiser or a person associated with an advertiser. The time and location specifications may be configured to control a time period when a particular advertisement is to be printed. The time period may include not only dates, but times of the day as well. For example, an advertiser may wish for an advertisement to be printed from 4:00 pm to 7:00 pm on one particular day. The location specifications designate particular printing locations where the tickets may be printed. For example, with respect to the printing of lottery tickets, lottery ticket printing devices may be housed in known stores, such as gas stations, convenience stores, grocery stores, restaurants, etc. In this way, the advertisers are able to control which locations are intended to print their advertisements.

As shown in FIG. 7, the ticket managing server 220 comprises a processing device 222, a database manager 223, an ad database 224, a ticket information database 226, a first interface device 228, a second interface device 230, a ticket image module 232, a security/identification module 234, and a random number generator 236. The processing device 222 may be configured to control the overall operations of the ticket managing server 220. The components of the ticket managing server 220 may be configured in a single computer or may be configured in multiple computer systems and interconnected by a suitable network or bus interface. The computer(s) may include one or more processing devices, such as general-purpose or specific purpose processors or microcontrollers for controlling the operations and functions of the ticket managing server 220.

The computer(s) may also include one or more memory devices, which may be configured as internally fixed storage units, removable storage units, and/or remotely accessible storage units, each including a tangible, non-transitory storage medium. The various storage units may include any combination of volatile memory (e.g., random access memory (RAM), dynamic RAM (DRAM), etc.) and non-volatile memory (e.g., read only memory (ROM), electrically erasable programmable ROM (EEPROM), flash memory, etc.). The storage units may be configured to store any combination of information, data, instructions, software code, etc.

In some embodiments, the components of the ticket managing server 220 may be implemented in hardware, software, firmware, or any combinations thereof. For example, portions of the ticket managing server 220 that are implemented in software or firmware may be stored on a non-transitory memory device, such as a computer-readable media device, and may be executable by a suitable instruction execution system, such as a processing device. The portions implemented in hardware may include discrete logic circuitry, an application specific integrated circuit (ASIC), a programmable gate array (PGA), a field programmable gate array (FPGA), or any combinations thereof.

The functions, operations, and/or programs executed by the ticket managing server 220 may comprise an ordered listing of executable instructions for implementing logical functions and can be embodied in any computer-readable medium for use by an instruction execution system or device, such as a computer-based system, processor-controlled system, etc. In the context of the present disclosure, a computer-readable medium can be any medium that can contain, store, communicate, propagate, or transport programs for execution by the instruction execution system or device. Examples of computer-readable media may include electronic, magnetic, electromagnetic, optical, infrared, or other systems or devices.

In some embodiments, the database manager 223 and ad database 224 may be omitted from the ticket managing server 220 and may be incorporated in a remote device and accessed via the first interface device 228 or second interface device 230. The advertisements may be bundled by the advertisement managing system 40, 104 and transmitted to the ticket managing server 220. In this case, the ticket managing server 220 controls the functions of ensuring that advertisements are printed along with ticket information. Otherwise, if this control is delegated to the advertisement managing system 40, 104, or, in some embodiments, delegated to the ticket printing devices 34, 84, then the database manager 223 and the ad database 224 may be omitted. The advertisements can be retrieved by the processing device 222 as needed, either from the ad database 224 or from a remote database.

In some embodiments, the ad database 224 and ticket information database 226 may be combined into a single database. However, it may be preferable to keep the information related to the ticket system separate from the advertisements, particularly since certain ticket information (e.g., lottery numbers) usually requires separation from the public. The ticket information database 226 may include ticket information such as lottery numbers printed on lottery tickets throughout a lottery system. The ticket information may also include the dates and times when the ticket information (e.g., lottery numbers) was printed and the location of the ticket printing device 34, 84 that printed the information.

The first interface device 228 and second interface device 230 may be combined into a single interface, according to some embodiments. For example, a single interface may suffice when the ticket managing server 220 is in communication with the network 88 shown in FIGS. 3A and 3B. When implemented as shown in FIG. 7, the interface devices 228, 230 may be configured to communicate over different networks. For example, the first interface device 228 may be configured to communicate with devices connected to a private network, such as the private network 36 shown in FIGS. 2A-2D, and the second interface device 230 may be configured to communicate with devices connected to another network, such as network 44 shown in FIGS. 2A-2D or network 88 shown in FIGS. 3A and 3B.

The second interface device 230 may be configured to receive the advertisement and/or advertisement strategies from the advertisement managing system 40, 104, the ad strategies created for advertisers representing advertisements and time/location information describing when and where the advertisements are intended to be printed. Also, the second interface device 230 may provide confirmation information back to the advertisement managing system 40, 104 confirming for the advertisers that the advertisements were printed. The confirmation information may include information regarding the advertisement printed and the time/date and location when and where the advertisements were printed.

The random number generator 236 is configured to randomly pick lottery numbers, particularly for a lottery system. For example, if a customer visits a location where a ticket printing device 34, 84 is placed and wishes to purchase a lottery ticket but does not wish to enter specific numbers, the numbers may be randomly generated either at the ticket printing device itself or at the ticket managing server 220. In this example, the ticket managing server 220 may be configured as a lottery server. Either way, the numbers eventually are communicated to the ticket managing server 220 and stored in the ticket information database 226 so that the ticket managing server 220 can verify if a winning ticket has been issued. If someone comes forward with an alleged winning ticket but the winning numbers do not match any ticket information communicated to the ticket managing server 220 and stored in the ticket information database 226, then it can be determined that the ticket may have been forged. Also, the security/identification module 234 may assist in verifying winning tickets. Referring again to the random number generator 236, when the ticket managing server 220 receives a request from a ticket printing device 34, 84 to provide random numbers for a particular lottery game, the processing device 222 can give the limitations of the random numbers (e.g., numbers from 1 to 40) to the random number generator 236 to obtain the lottery numbers to be printed on the lottery ticket at the ticket printing device 34, 84.

The ticket image module 232 shown in FIG. 7 may be configured to combine the ticket information (e.g., lottery numbers) with an advertisement selected from the ad database 224 or other data source. Regarding the example of the lottery system, the lottery numbers may be obtained randomly from the random number generator 236, obtained randomly from a random number generator at the ticket printing device 34, 84, or obtained from numbers entered manually at the ticket printing device 34, 84. The processing device 222 may be configured to select an advertisement from the ad database 224 based on several factors. For example, the advertisements may be stored along with specific printing criteria for defining that advertisements are to be printed at only certain ticket printing devices 34, 84. When a ticket image is to be combined by the ticket image module 232, an advertisement, which is associated with the particular ticket printing device 34, 84 where the ticket information is to be printed, is selected. Also, certain time parameters are stored as well. These parameters indicate when the advertisements are to be printed. As an example, an advertiser may create an advertisement with instructions to print the ad only at a certain location (e.g., a ticket printing device located at a Speedway gas station in Buford, Ga.) between the hours of 2 pm and 7 pm on Friday Oct. 5, 2012. If at least these criteria are met, this particular advertisement is combined with the ticket information (e.g., lottery numbers) in a particular fashion (as described below).

If more than one advertisement is scheduled to be printed at a certain location at a certain time, other criteria may be analyzed by the processing device 222 to determine which advertisement is actually selected. For example, the selection may be based on how many more times an advertisement is to be printed, how much an advertiser is paying for each advertisement, how close the current time is to an end time parameter for an advertisement, and/or other algorithms or parameters.

In some embodiments, the ticket managing server 220 may be configured to create a place holder on a ticket where an advertisement is to be printed. The ticket information can be printed in other sections of the ticket, but the place holder is reserved for only the advertisement. This allows tickets to be printed in advance and then an advertisement can be printed in a particular section of the ticket (i.e., where the place holder is located) to complete the printing process. Parameters may be set to designate where an ad will go and then it is retrieved from the ad database 224 or other source to be printed.

The advertisement managing system 40, 104 may be configured to create advertisement strategies for advertisers, where each advertisement strategy includes an advertisement, a time period when the advertisement is to be printed, and one or more locations where the advertisement is to be printed. The ticket managing server 220 may be configured to receive the advertisement strategies in bundles to be distributed to multiple ticket printing devices 34, 84. The ticket managing server 220 may then control the distribution to the printing devices based on the criteria in the advertisement strategies. This information may also be transmitted in bundles to the individual ticket printing devices 34, 84 or distributed one at a time when needed. When bundled, the advertisements to be run at a certain time or on a certain day may be transmitted to the ticket printing device 34, 84, which will then store the advertisements and print them during the designated times. For example, if ads are to run at a particular location from 6:00 to 7:00 pm, the ads may be transmitted to the ticket printing device 34, 84 at 5:00 pm. The way in which the advertisements are transmitted to the ticket printing device 34, 84 may be different from the way that the advertisements are transmitted from the advertisement managing system 40, 104 to the ticket managing server 220.

The security/identification module 234 is configured to analyze the advertisement strategies, both when they are received from the advertisement managing system 40, 104 and before they are transmitted to the ticket printing devices 34, 84. If it is determined that an ad is corrupted, the security/identification module 234 may inform the processing device 222 about the corruption to filter out the ad and prevent the ad from being sent to the printing device. Also, when corrupted, the processing device 222 may be configured to retrieve a default or replacement ad from the ad database 224. The default or replacement ad may be an advertisement from a major advertiser (e.g., Coca-Cola). Corruption may be detected by the security/identification module 234 if it is determined that the identity of a file contains improper or unauthorized elements that do not match certain codes, format, or protocols. For example, the components of the advertisement systems 30, 50, 60, 70, 80, and 100 may have synchronized coding/decoding elements, encryption/decryption elements, etc. to allow proper security throughout the system. Other format information may also be common throughout the system, such as the size and shape of an advertisement or place holder, the resolution (dots per inch) of the advertisement, and other factors. Also, the security/identification module 234 as with other security modules throughout the system may check the identity of the components that sent the advertisements and/or advertisement strategies. For example, the identity may be checked by analyzing the MAC address, IP address, or other computer/device identification codes of the device that provided the data. Security throughout the system may also be checked by running algorithms that are coordinated with each authorized device.

### Ticket Printing Device

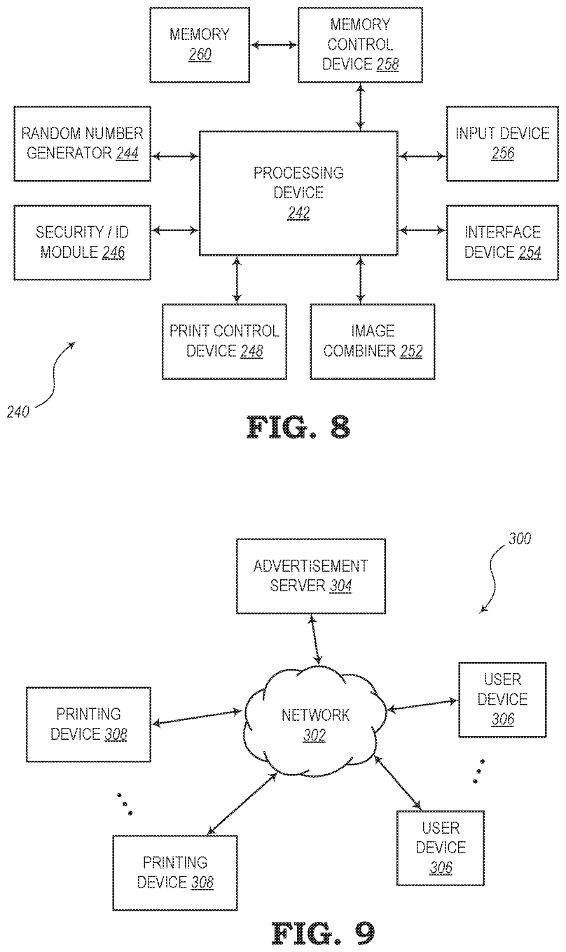

FIG. 8 is a block diagram illustrating an embodiment of a ticket printing device 240. The ticket printing device 240 may represent the ticket printing device 34 shown in FIGS. 2A-2D and/or the ticket printing device 84 shown in FIGS. 3A and 3B. As illustrated in the embodiment of FIG. 8, the ticket printing device 240 comprises a processing device 242, a random number generator 244, a security/identification module 246, a print control device 248, an image combiner 252, an interface device 254, an input device 256, a memory control device 258, and a memory 260. The ticket printing device 240 may be a computer terminal, a simple printer, or some intermediate type of device, depending, for example, on the vendor, state, etc. According to various implementations, some components may be omitted and/or incorporated in other devices, such as in the ticket managing servers or advertisement managing systems. For example, the random number generator 244, image combiner 252, memory control device 258, and memory 260 may be omitted in some embodiments, perhaps depending on the particular type that the ticket printing device 240 is and the features that it might have.

As mentioned above with respect to the ticket managing server 220, the ticket printing device 240 may comprise a random number generator 244. However, according to alternative embodiments, the random number generator 244 may be omitted and random numbers may be obtained at the ticket managing server 220 instead. The processing device 242 may be configured to control how the limitations of the numbers that are randomly generated by the random number generator 244 are obtained. For example, if the customer wishes to play a Pick 4 lottery game that involves picking four numbers ranging from one to ten, then the processing device 242 may request the random number generator 244 to pick four numbers ranging from one to ten. If random numbers are generated remotely, the numbers may be communicated to the ticket printing device 240 via the interface device 254.

If the customer wishes to choose his/her own numbers instead of having a machine randomly pick them, the customer's numbers can be entered using the input device 256. The input device 256 may be a keypad, keyboard, or other type of entry device allowing numbers to be entered manually. Also, the input device 256 may include a scanner that is configured to scan papers or cards having the customer's numbers shaded in, punched out, marked up, or indicated in some other way.

The security/identification module 246 may include the same features as the security/identification module 234 as mentioned above with respect to FIG. 7. The security/identification module 246 may check to make sure advertisement information is legitimate as it is received and before it is printed.

As described in the present disclosure, the ticket printing device 240 not only prints a ticket (e.g., a lottery ticket or other type of ticket), but also is configured to print an advertisement on the ticket as well. A feature of the ticket printing device 240 is that the advertisement to be printed is not a single advertisement that is printed on all tickets, but may be an advertisement selected from among a plurality of advertisements. Also, the times when the advertisements are to be printed can be specified to allow an advertiser to control a specific time frame when the advertisements are printed. Also, the actual location of the ticket printing device 240 (e.g., within a specific store at a specific address) can also be selected by the advertiser such that advertisements are only printed at locations where the advertiser chooses (e.g., only at stores within a five mile radius from the advertiser's establishment).

Advertisements may be stored remotely from the ticket printing device 240 according to some embodiments. In this case, the advertisement may be selected according to specific time and location parameters and transmitted to the ticket printing device 240. If the ticket information (e.g., lottery numbers) and selected advertisement are not already combined into a single image, the ticket printing device 240 may be configured to combine the images using the image combiner 252. The image combiner 252 prints the ticket information (e.g., lottery information) on one section of the ticket and prints the advertisement information on another section of the ticket. In some embodiments, the printing of the two sections may be done in one printing session. Alternatively, one section may be printed at an earlier time and the other section may be printed later to complete the printing process. Also, it may be preferable that the two sections of the ticket (representing the ticket information in one section and the advertisement information in another section) are separated from each other. However, in other embodiments, the sections may overlap to some degree. The ticket printing device 240 may follow any of various printing implementations for printing the two sections.

As mentioned above, advertisements may be stored remotely, such as in a database associated with the ticket managing server 220 and/or advertisement managing system 40, 104. In this case, the advertisements may be provided to the ticket printing device 240 one by one as needed (e.g., when a ticket is to be printed). According to some embodiments, the advertisements may be bundled together and transmitted to the ticket printing device 240 via the interface device 254. The bundled advertisements may be stored in memory 260. Then, when an advertisement is to be printed, the memory control device 258 is configured to run an algorithm to select an advertisement that is to be printed. The memory control device 258 selects the advertisement from memory 260 and supplies the ad to the image combiner 252, where the advertisement is combined with the ticket information.

The memory 260 may also store a default image that may be printed if there are no advertisements that meet the selection criteria of the memory control device 258. For example, a default image may include a simple text image informing potential advertisers that they may “Advertise Your Business Here” or other messages. The default image may also include contact information, such as a phone number, web address, or other information to allow a potential advertiser to enter an advertisement to be printed with tickets as described herein. Another type of default ad may include an advertisement for a low cost and/or high volume advertiser (e.g., Coca-Cola™). The memory 260 may also store a separator image, such as a line, dashed line, dotted line, etc. that separates the first section having the ticket information from the second section having the advertisement information. The separator may also include text, such as “cut here” or other message indicating the separateness of each portion of the ticket. In this way, if the advertisement is a coupon that may be redeemed at a certain establishment, the ticket can be cut or ripped along the separator line and the coupon can be used without also handing over the ticket, which may include lottery numbers for an upcoming lottery or other useful ticket information to provide other privileges to its holder.

The print control device 248 may include printing heads, ink jets, paper dispensing devices, or other printer mechanisms for printing onto paper or other paper-based material. In some embodiments, the print control device 248 may also include other features for cutting off a ticket if the ticket is printed from a roll of paper, thus allowing the ticket to be completely severed from the roll. The print control device 248 may also be configured, according to various implementations, to create perforations along the separator line that separates the ticket information section from the advertisement information section. Thus, with perforations formed in the ticket, the ticket may be easily ripped into two separate pieces, where one piece can be handed to an advertiser to redeem a coupon, for instance, and the other piece can be kept allowing the ticket-bearer to enjoy the benefits of the ticket privileges. The print control device 248 can also provide half-cuts for easy detachment. Also, the print control device 248 may also be configured to print on both the front and back of the paper or card. For example, in some embodiments, the ticket information may be printed on one side of the ticket and the advertisement may be printed on the other side. Also, the print control device 248 may be configured to receive a ticket that already has preprinted ticket information on it with a place holder for an advertisement, such that the print control device 248 only prints the advertisement. In other embodiments, the ticket information and advertisement are printed at the same time.

If the processing device 242 is configured to receive advertisement information immediately before printing and determines from the interface device 254 that the network is busy, unavailable, or has some other issue, then a default or replacement ad may be retrieved from memory 260 and printed. After an advertisement is printed, the interface device 254 is configured to send confirmation information about the advertisement that was printed and the time/date when it was printed. This information may be stored in memory 260 and sent as a group on a scheduled basis (e.g., once a day, once a week, etc.). The information is sent to the advertisement managing system 40, 104 either directly or via the ticket managing server 32. Regarding lottery embodiments, the interface device 254 also communicates lottery numbers to the ticket managing server 32.

As described in the present disclosure, the ticket printing device 240 may comprise means for retrieving an advertisement from memory, such as the memory control device 258. The ticket printing device 240 also includes means for receiving ticket information, which may include any one or more of the input device 256, random number generator 244, and interface device 254. The ticket printing device 240 also includes means (e.g., print control device 248) for printing the ticket information and advertisement on a single ticket. The ticket information, for example, includes information that entitles the bearer of the ticket to one or more privileges.

The ticket printing device 240 may further comprise the memory device 160 configured to store one or more advertisements. The means for retrieving the advertisement may comprise an interface (e.g., interface device 254) configured to retrieve the advertisement from a remote database (e.g., ad database 224).

The ticket printing device 240 may be configured such that the single ticket that is printed is a lottery ticket. The ticket printing device 240 may therefore further comprise a random number generator configured to generate a plurality of lottery numbers to be printed on the lottery ticket.

The means for printing (e.g., print control device 248) may be configured to print the single ticket with a ticket section separated from an advertisement section. The ticket section may include at least the ticket information and the advertisement section may include at least the advertisement. The ticket section may be printed above the advertisement section on the ticket. The advertisement section may be oriented at an angle with respect to the ticket section. The advertisement section may be printed with at least one of a quick response (QR) code 182 and a barcode. The ticket printing device 240 may further comprise means for creating a perforation (e.g., print control device 248) separating the ticket section from the advertisement section. The means for printing (e.g., print control device 248) may also be configured to print at least the ticket information on one side of the ticket and print the advertisement on the other side of the ticket.

### Printing Advertisements on Other Media

According to other examples, advertisements may also be printed on various types of media, such as paper, cardstock, cardboard, plastic, Styrofoam, metal, or other suitable media. In particular, the implementations disclosed herein may include printing an ad on an item associated with a purchase. For example, these items on which the ads are printed may be items used for delivering a purchased product to a customer or items used by the customer when consuming the purchased product. The items on which the ads are printed may also be disposable items. In some embodiments, ads may be printed on items associated with a purchase, such as those used in fast food restaurants, coffee shops, grocery stores, and other stores serving food, drinks, desserts, etc. For example, the ad-bearing items may include beverage cups, napkins, sandwich/burger wrappers, French fry containers, paper placemats, tray liners, paper take-out bags, paper grocery bags, pizza boxes, flyers glued to pizza boxes, stickers or flyers applied to various disposable products, coffee/hot-beverage cups, heat-insulating sleeves used on coffee cups, etc. In this respect, the advertising systems may be in communication with fast food restaurants or other food or beverage stores to enable an advertiser to advertise at specific locations. The advertisements are thereby provided to customers making a food or beverage purchase at a known location and time. Because of the time and location aspects of the advertisement systems of the present application, the advertisements can be strategically provided to customers according to predetermined advertisement arrangements. Also, new advertising campaigns can be quickly implemented due to sudden changes or newly discovered needs.

Using the implementations described in the present disclosure, an advertiser can create one or more advertisement strategies using a process involving online systems, as described above. The advertisements can then be distributed to printing devices in food or beverage service facilities to be printed for individuals who wish to purchase food and/or beverages. The advertisement can be printed in a designated spot on the item associated with a purchase, such as on a disposable item, and may include a predetermined size or shape, depending on the particular item being advertised on. As mentioned above, advertisers can choose where the advertisements are to be printed. Therefore, the advertisements can be distributed to people who might live or work in a specific area (e.g., near the fast food or beverage store). Further, advertisement campaigns can be tailored to fit within an individual community where the ads will appear. Printing devices located within the stores may include location information to specifically identify the location of the store.

FIG. 9 is a block diagram illustrating an embodiment of an advertisement system 300 according to various implementations of the present disclosure. The advertisement system 300 of FIG. 9 includes a network 302 configured to enable communication among a number of electronic components. The network 302 may include a wide area network, such as the Internet, a local area network, and/or other suitable types of networks. The advertisement system 300 also includes an advertisement server 304 configured to enable advertisers to create and/or upload advertisements, select day and time information to specify when they want the advertisements printed, and select location information to specify where they want the advertisements printed. The entry of location, day, and time information may be similar to the embodiments described above.

The user devices 306 of the advertisement system 300 may include remote computing devices (e.g., computers, laptops, mobile devices, etc.) that allow a user to enter specific advertisement information. The user devices 306 communicate with the advertisement server 304 to create/upload advertisements and select time, date, and location information. The selected locations correspond to specific locations (e.g., fast food restaurants, grocery stores, coffee shops, etc.) where printing devices 308 may be placed. Therefore, one or more advertisements sent to the printing devices 308 from the advertisement server 304 via the network 302 are intended for the particular store or restaurant where that printing device 308 is located. A worker at that facility can then use the printed advertisement that is printed on a particular item (e.g., disposable container or other suitable medium) associated with a particular purchase. That item may then be used for its typical purpose, such as for holding, containing, or wrapping foods and/or beverages or serving some other purpose associated with the fast food and/or beverage industry.

The advertisement system 300 of FIG. 9 may include security measures that are incorporated throughout the respective system. Thus, when an advertisement is created, security elements are added. Also, when advertisements are distributed to the printing devices 308, the security elements can be verified to ensure that the advertisements are authentic. Furthermore, when an advertisement is printed, the printing devices 308 may also be configured to check the security elements. The security elements may include encoding/decoding protocols, encryption/decryption protocols, or other protocols known to the advertisement server 304 and printing devices 308. In some embodiments, the components of the advertisement system 300 may utilize code characters, passwords, or other codes that are configured to change in a certain way. For example, a code number may increase by a certain value on a regular basis (e.g., every day). Also, the components of the systems may be configured to use and check for certain advertisement characteristics to ensure security. For example, these advertisement characteristics may include a specific size of an image of the advertisement, a specific type of file, a file naming convention, a specific number of dots per inch (dpi) for the advertisements, or other characteristics.

Not only can the advertisement system 300 of FIG. 9 be used for advertisements, but it can also be used for promoting or announcing local events, promoting brand affinity with local organizations (e.g., local sports teams), promoting special events (e.g., sporting events, fairs, festivals, etc.), and raising money for charity. The advertisement system 300 allows advertisers to easily target specific areas. Also, advertisers can run advertisements at specific times, depending on local events or other occurrences that may have a limited duration (e.g., a fair or circus in a local area, etc.).

As opposed to a system that prints advertisements in bulk for one advertiser, the advertisement system 300 of the present disclosure enables multiple advertisers to advertise as many advertisements as they wish and have the advertisements targeted at only certain locations. In this regard, the present disclosure provides a variable system that can select from among a plurality of advertisements, depending on various parameters. Also, the advertisements can be printed on a medium that can be easily viewed by a consumer, particularly during a time when the consumer is eating or drinking. During this time, a consumer's attention is normally directed to their food and/or beverage, thereby giving the consumer many opportunities to see the item on which the advertisement is printed and making the advertisement more effective.

The advertisement server 304 is also configured to enable an advertiser to create an advertisement strategy or advertisement campaign, as mentioned above. An advertiser can create advertisement strategies by entering information regarding the actual advertisement content, one or more locations where the advertisement is to be printed and used, one or more days, times of the days, the types of items on which the advertisements are printed, and other factors.

The printing devices 308 may also be configured to communicate with the advertisement server 304 to provide information about the details of the advertisements that were printed. Thus, the printing devices 308 provide verification that the advertisements were printed as scheduled. The verification information may include information regarding which advertisements were printed, the location where the advertisements were printed, the time and date when the advertisements were printed, the item on which the advertisements were printed, the time when the printed item was given to a customer, and other relevant information.

Communication between the advertisement server 304 and printing devices 308 may be limited to specific times of the day or specific days of the week, depending on various implementation. Communication involves providing advertisements to the printing devices 308 with instructions for printing. Communication also involves providing confirmation back to the advertisement server 304 of the printing of advertisements.

The advertisement server 304 shown in FIG. 9 may be configured similarly to the ticket managing server 220 of FIG. 9. Also, the printing devices 308 shown in FIG. 9 may be configured similarly to the ticket printing device 240 of FIG. 8. However, instead of being configured for printing on tickets, the advertisement server 304 and printing devices 308 are configured to print on other types of media as discussed above. The details of the advertisement server 304 and printing devices 308 are therefore omitted here for the sake of brevity.

Therefore, according to some implementations, an advertising system may comprise an advertisement server configured to manage the printing of advertisements at a plurality of predetermined locations and at a plurality of predetermined times. The advertising system may comprise a plurality of printing devices operating at the plurality of predetermined locations, each printing device configured to print advertisements on items associated with purchases at various stores, restaurants, or shops. A network may be configured to enable communication between the advertisement server and the plurality of printing devices. Thus, the printing devices are configured to print the advertisements according to the plurality of predetermined times based on when at least one advertiser intends for the advertisements to be printed.

The advertisements may be printed at the time of purchase or printed in advance. Also, the advertisements may be printed individually or in bulk. An example of preprinting in bulk might include a situation where a fast food restaurant preprints placemats intended for use for that week, day, or hour. This would allow the advertisers to still choose a location and a time window for the ad placement while allowing the restaurant to prepare the placemats ahead of time to ensure there is no delay during a rush.

### Displaying Advertisements on Electronic Devices

In some embodiments, the advertisement system 300 may further include means for issuing mobile advertisements, such as advertisements on cellular phones, smart phones, or other mobile devices. The advertisements may be supplied to a mobile device based on a GPS location of the consumer, the consumer's purchases, or other factors. The advertisement may be sent via a prerecorded phone message, a text message, or other communication. Advertisements sent to a mobile device may allow the particular establishment to offer a unique advertisement to mobile device users. For example, a fast food restaurant may offer a customer on the premises a special deal on desserts.

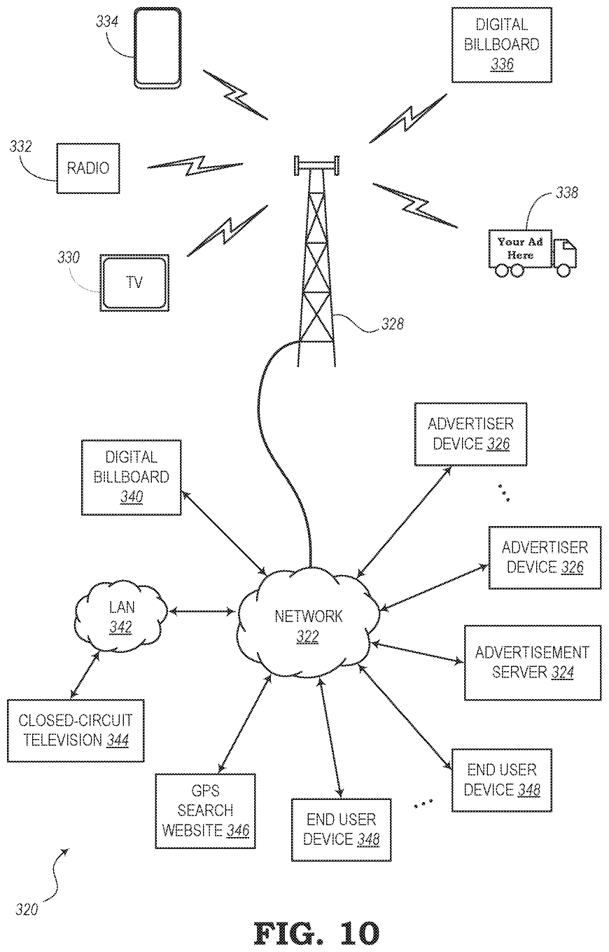

FIG. 10 is a block diagram illustrating another embodiment of an advertisement system 320. In this embodiment, the advertisement system 320 includes, among other things, one or more networks 322, an advertisement server 324, and one or more advertiser devices 326, which are similar to the public networks, servers, and user devices described above with respect to other embodiments. An advertiser can create and/or upload one or more advertisements to the advertisement server 324 from the advertiser device 326 and create advertisement campaigns. However, instead of advertisements being printed on tickets or on other media, as described above, the advertisement system 320 of FIG. 10 presents advertisements in visual and/or audible form on one or more digital devices.

The advertisement system 320 may include one or more antennas 328. The antennas 328 may be in the form of antenna towers, cellular towers, broadcast television towers, radio towers, and may be associated with other suitable broadcasting antennas, towers, satellites, and other equipment for wirelessly broadcasting signals to remote locations. For example, the antennas 328 may broadcast advertisements to televisions 330, radios 332, mobile devices 334, and other wireless signal receiving devices.

The antennas 328 may also include proprietary communication equipment for wirelessly communicating to specific advertising devices. For example, the antennas 328 may communicate with digital billboards 336 to provide advertisements to be displayed on the digital billboards 336.

The antennas 328 can also wirelessly communicate advertisement information to an advertising vehicle 338. The advertising vehicle 338 may be a truck, van, automobile, or other vehicle. The advertising vehicle 338 includes a digital display device, which may be mounted to a side panel or back panel of the vehicle. In this respect, advertisements may be presented to and observed by other drivers or passengers in the vicinity of the advertising vehicle 338. In some embodiments, the advertising vehicle 338 may include a GPS device for determining the location of the vehicle. The location information can be communicated to the advertisement server 324, which may select specific advertisement(s) based on the vehicle's location. If the vehicle travels over a long distance, the displayed advertisement may be changed, depending on whether the advertisements are targeted to customers in particular areas.

For instance, a truck travelling from New York to Miami may have a digital billboard display that changes along the way. The advertisements can be updated automatically based on the particular location and the proximity to different cities. Ads displayed on the truck's digital billboard display can also be automatically changed based on highway exits. For instance, when the truck passes one exit, the advertisements can be changed to advertise for restaurants, gas stations, local sites, or other businesses that may be near an upcoming exit. The updated ads can then show nearby drivers at least some options for restaurants or gas stations at upcoming exits. In this embodiment, the advertising portal of the present disclosure may further be configured to allow an advertiser to enter not only location information, but also directional information with respect to the travelling advertisement vehicle. For example, an advertiser may wish to advertise for a gas station at a specific exit (e.g., exit 45) when the truck or other travelling advertisement vehicle is travelling on a certain highway in a certain direction (e.g., travelling south on I-95) when the truck is approaching the specific exit (e.g., between exit 45 and exit 55).

The one or more networks 322 may include any number of networks for communication over various protocols. For example, at least one network 322, such as the Internet, may include TCP/IP communications, including electrical and fiber cable communications and/or wireless communication. Also, the one or more networks 322 may include telephone lines, cellular phone transmission antennas, satellites, and/or other phone communication equipment, which may operate in conjunction with the antennas 328.

The advertisement system 320 also includes digital billboards 340 which include wired communication with the network 322. The digital billboards 336 and 340 may be similar to each other except for the manner in which they receive the advertisement information (i.e., via wireless transmission or wired communication).

The network 322 may be connected to other networks, such local area networks (LANs) 342. The LANs 342 may include one or more closed-circuit televisions 344 or other types of closed-circuit display devices. In this respect, a control device operating on the LAN 342 may be configured to receive advertisement information from the advertisement server 324 via the network 322 and LAN 342 and forward the advertisement information to the closed-circuit televisions 344 as directed. The LANs 342 and closed-circuit televisions 344 may be located in many different areas, such as airports, bus stations, train stations, stadiums, auditoriums, banks, restaurants, amusement parks, or other areas.

In some embodiments, a GPS search website 346 may be associated with the advertisement server 324. The advertisement server 324 may be configured to determine when an end user requests a specific search for a location provided by the GPS search website 346. When such a search is conducted, the advertisement server 324 is configured to provide advertisement information to the GPS search website 346, which then combines the search results with advertisements specifically directed to advertisers in the vicinity of the specific GPS search results. In addition, the GPS search website 346 may also provide advertisement information specifically directed to advertisers located in between the user's location and a search destination or along a path that a user may travel from a start location to a destination location.

The advertisement system 320 of FIG. 10 may also include communication of advertisement to specific end user devices 348. For example, end user devices 348, such as computers, laptops, mobile devices, smart phones, or other devices may be used to stream video and/or audio from online websites. These services may include video on demand, audio on demand, online entertainment channels, Internet television programs, Internet radio programs, and others. Based on specific selections by the user of the end user device 348, the advertisement server 324 combines advertisement information to the end user device 348 for presentation along with the requested video and audio.

The advertisement server 324 and advertiser devices 326 of the advertisement system 320 of FIG. 10 may include many of the same features described above with respect to other servers and user devices associated with other embodiments. The advertisement system 320 may also include security measures that are incorporated throughout the system. Security elements of the advertisement system 320 may include various protocols as mentioned above, which may be utilized by some or all of the components of the advertisement system 320.

Since electronic devices, which are capable of presenting advertisements, seem to be ubiquitous, the advertisement server 324 may include a database that stores the locations of the devices and/or may include a search function for electronically searching for the devices. When the locations of multiple electronic devices are known, an advertiser can select the electronic devices on which to advertise. For example, an advertiser may wish to advertise on a national level, a statewide level, a county level, a city level, a neighborhood level, a school district level, a street level, or even a single location (e.g., store, shop, house, etc.). If multiple electronic devices are located at a single location, an advertiser can even select one or more of the electronic devices at that location. This selection process allows the advertisers to specifically target the electronic devices on which to advertise.

Therefore, according to some implementations, an advertising system may comprise a plurality of electronic devices and an advertisement server configured to manage the display of a plurality of advertisements on the plurality of electronic devices. At least one network may be configured to enable communication between the advertisement server and the plurality of electronic devices. The electronic devices may be configured to display the plurality of advertisements according to predetermined time parameters when at least one advertiser intends for the advertisements to be printed.

### Three-Dimensional Printing and Etching

The systems of the present disclosure may also be used in systems that are configured for three-dimensional printing, etching (e.g., laser etching, chemical etching, etc.), and other various forms of graphical creation. Three-dimensional printing and etching may be executed at predetermined locations where appropriate three-dimensional printers and/or etching equipment are housed. For example, a fast food restaurant may have three-dimensional printing and/or etching equipment for creating and/or modifying a small token or toy that is given to customers. With such equipment on location, the restaurant is able to provide customized advertisements or other types of printing (e.g., etching a customer's name) on the token or toy. The customized object can include advertisement information on any surface of the object.

The three-dimensional printers and/or etching equipment may be substituted for the printing devices or digital devices described above with respect to the other embodiments. The process of creation/uploading advertisements may be similar to the above-described embodiments, except that the advertisements to be printed three-dimensionally and/or etched onto a surface may include additional information regarding spatial features, depths of etching layers, colors, etc. Three-dimensional ads may also take the form of a projection or display, such as a holographic image or 3D video, which can be shown in a 3D projector, a 3D headset, or other 3D displaying system.

In some embodiments, objects on which advertisements are printed or etched may be treated by the application of light, energy, chemicals, heat, or other resources. Advertisements may become visible by adding material to the objects or removing material.

Therefore, according to some implementations, an advertising system may comprise an advertisement server configured to manage the creation of advertisements at a plurality of locations and at a plurality of times. The advertising system may also comprise a plurality of printing/etching devices operating in the plurality of predetermined locations, each printing/etching device being configured to print or etch advertisements onto three-dimensional objects. A network may be configured to enable communication between the advertisement server and the plurality of printing/etching devices. The printing/etching devices may be configured to print or etch the advertisements at the plurality of times according to when at least one advertiser intends for the advertisements to be printed.

### Conditional Advertising

The advertisement servers described above may also be configured to enable an advertiser to select or create advertisements that are printed or presented when certain conditions are met. For example, conditional advertising may be established beforehand to allow advertising to be based on real-time events. For example, an advertiser may wish to advertise for ice cream when the temperature in a particular area is extremely hot or is above a certain temperature. Or an advertiser may wish to advertise for flashlights, batteries, and other emergency supplies if a severe storm is expected to hit a certain area. Or an advertiser may wish to draw customers away from heavy traffic areas to locations of stores where there is less traffic. Also, special deals may be offered if certain products are not selling as expected.

Therefore, conditional advertising can be based on any number of measures, such as temperature, current weather conditions, weather forecasts, traffic conditions, current events, local events, upcoming events, supply/demand figures, and other factors. The conditional events may be based on a simple yes/no condition (e.g., a school day or not a school day) or may be based on the degree of a certain factor (e.g., more than 4 inches of snow in the forecast). Any number of conditions may be selected ahead of time for defining the particular times or conditions when an advertiser wishes to print or display the advertisements.

Also, the advertising servers may be configured to adjust the pricing of advertisements based on one or more of the conditions. For example, if a town has a special event that attracts a large number of people to the town, the cost for advertising may be increased since the demand may be greater.

Conditional advertising may also be based on factors regarding competing advertisers. For example, the advertisement servers may honor advertisers based on a first-come, first-serve basis. Alternatively, the advertisement servers may utilize an advertisement selection based on the highest bidder for a particular advertisement space or timeslot.

Ordering Multiple Types of Ads from Multiple Vendors

The present disclosure further describes systems for ordering, creating, and distributing multiple types of advertisements across a variety of advertisement mediums from a variety of advertisement providers. An advertiser can order the delivery of an advertisement to be printed or displayed at one or more specific locations at one or more specific times. The boundaries of the specific location(s) as well as the boundaries of the time window(s) can be predetermined or set by the advertiser. Examples of locations include, but are not limited to, ads to be displayed at one specific location, within a certain distance (e.g., a one-mile, five-mile, or ten-mile radius) from a location, or within the borders of a country, state, city, county, or other jurisdiction. Examples of times include, but are not limited to, a certain time or time period on a certain day, within multiple times or time periods of a certain day or days, within a set of hours on a certain day, within certain hours each weekday, within a certain year, month, week, or day, continuing from an immediate time until the end of a certain time or condition, or other times. Further, locations can represent the site, sites, building, buildings, complex, or other structures of a business or other pre-defined static locations. Also, the locations can represent one or more moving locations (e.g., a vehicle, mobile phone, etc.) that can be determinable by GPS or other means.

Ad types can be audio, audio/visual, a single image, a moving image, an image on a ticket, on a toy, on a food wrapper or cup, on a digital billboard, on a digital display in public, on a digital display on a mobile device, on a display at a mall, or other types of advertisements. Ads can be printed in one or more sections and placed on a traditional billboard. Ads can be displayed on a traditional television, Internet TV, traditional radio, or Internet radio. Ads can also be presented as 3D projections at a certain location, such as at a shopping mall, theater, restaurant, home, etc. Ads can also be projected/displayed within a 3D headset or display, such as within a virtual reality system. Ads can be interactive ads that a viewer can interact with.

In some embodiments, the advertisement managing system 40, 104, advertisement server 304, 324, or other system or device for managing or controlling the ordering, creating, and/or distribution of advertisement may utilize one or more portal devices, websites, or other suitable control devices. The portal devices may be associated with one or more ad sellers who sell multiple types of ads through the portal device. An ad buyer may be anyone from an individual person to a multinational company may use the one or more portal devices for designing, ordering, managing, and paying for ads and ad campaigns. The portals may also be used to analyze the success of one or more ads. The analysis of the success of the ads may be determined based on targeted vs. mass marketing, location information, time information, etc.

The advertisement portals/websites may be configured to enable advertisers to create and/or upload their own ads. Advertisers can create campaigns where they order certain ads in certain areas at certain times. The ad orders may be conditional as mentioned above. In some embodiments, advertisers may use advertising agents and/or agencies in various markets for various types of ads. Further, advertisers may have various entities within their corporate structure that have control over certain ads or ad campaigns, such as an international office, national office, regional office, local office, etc.

The advertisement portals, according to some embodiments, may allow for the option of multiple interactive hierarchal accounts. For instance, an ad agency may have numerous accounts for their various clients. The clients may have multiple accounts with multiple ad agencies, perhaps where each ad agency may specialize in advertising in various parts of the world and in various types of advertisements or advertisement mediums. The clients may also comprise various levels within their own corporate structure that may be international, national, regional, local, etc. While there may be multiple ad providers, multiple ad agencies, and multiple corporate entities, the portal or portals of the present disclosure can provide a common way for ordering, creating, organizing, distributing, and tracking ads across all the providers and agencies in a manner that can be customized and organized to fit the needs of the various users.

The advertisement arrangement may be arranged such that various levels or hierarchies will have the option to give or restrict certain rights. For instance, one ad agency may give a client full rights to order ads, while another may put restrictions on some clients, such as a spending limit. One company may give a local branch only the rights to place ads locally etc. The advertising portals may allow these rights and permissions to go in both directions. The advertising portals can be used to control the various rules, restrictions, limits, etc. on the various entities. Thus, an ad agency can utilize the advertising portals to limit the spending of the client, or the client can utilize the advertising portals to limit the spending of the agency.

### Variable Determinable Content Printing

According to some embodiments of the present disclosure, systems may be configured for printing or displaying “variable determinable content” at a point of sale (POS) terminal. Variable determinable content may refer to determining certain additional information that may be printed or displayed based on purchases made at the POS terminal. One example of this is where a customer may place a special order at a fast food restaurant, such as a burger with extra cheese. The systems of the present disclosure may be configured to make various calculations, such as calculating the change in calories of the burger. The systems may also print or display a list of ingredients, calorie and nutrition information, and other information based on the changes in the special order. Such systems may also include the same or similar security and delivery options as mentioned above for the advertisement systems.

Securely Transmitting Ads over a Network

In some embodiments, the systems and methods of the present disclosure may be configured to incorporate various security elements into advertisements for distribution throughout a network (e.g., centralized network, decentralized network, or a combination of both). For example, the networks 44, 88, 302, 322 described above may be configured as decentralized networks, centralized networks, or any combinations thereof. The advertisement managing systems 40, 52, 82, 104, 120 may be configured with security devices for encrypting advertisement information, such as using blockchain technologies, Non-Fungible Token (NFT) technologies, etc.

For example, the security/identification module 148 of the advertisement planning device 122 may be configured to securely encrypt advertisement using blockchain technologies to ensure that advertisements are not altered. In addition, with blockchain, the originators of the advertisements can be recorded to thereby prevent copyright issues or other similar problems. In some embodiments, the security/identification module 148 may operate with the security/identification modules 234, 246 associated with ticket managing servers and ticket printing devices. As such, information regarding the number of times that an advertisement is printed can be recorded in an encrypted file (e.g., using blockchain).

Furthermore, the advertisement distribution device 128 of the advertisement managing system 120 (or other similar control or management systems) may also be configured to add security elements to advertisement information for distribution over the network. Again, the security elements may include blockchain. Also, the financial management device 132 of the advertisement managing system 120 may be configured to utilize blockchain and/or NFT technologies, cryptocurrency, smart contracts, tokens, coins, etc. for securely exchanging money, currency, etc. For example, the financial management device 132 may calculate a fee that is charged to an advertiser for submitting an advertisement campaign. Also, the financial management device 132 may calculate a fee that is charged to the advertiser every time the ad is displayed on the media device (e.g., ticket printing device, mobile device, etc.). Also, the payment calculation module 147 of the advertisement planning device 122 may also use blockchain, NFT, cryptocurrency, tokens, coins, etc. for performing financial transactions related to advertisement management. As mentioned above, the quantity module 146 may be configured to determine each time the ad is displayed, which can be used in this calculation. Again, these financial calculations can be stored using blockchain.

### Advertisement Security Processes

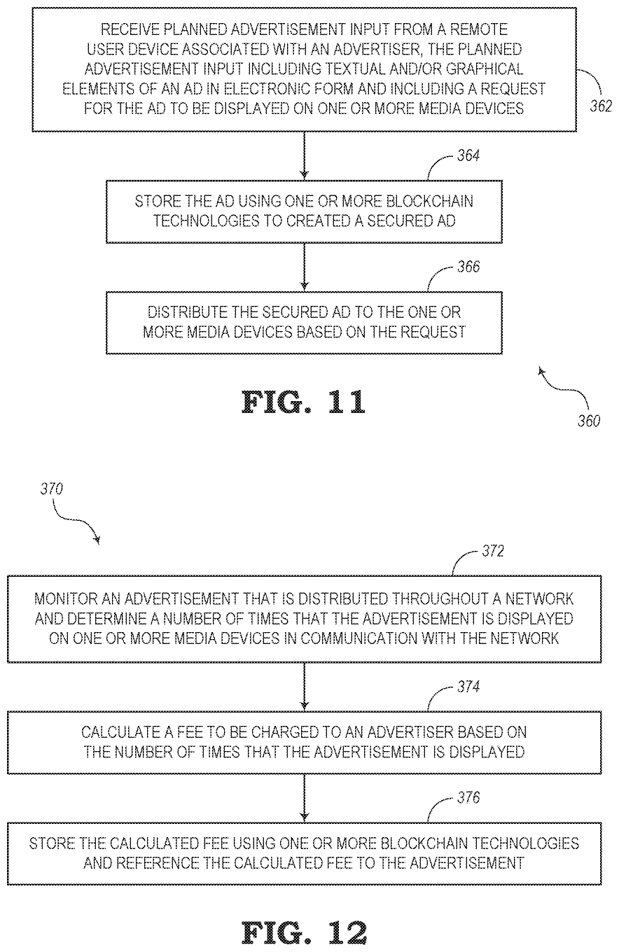

FIG. 11 is a flow diagram illustrating an embodiment of a method 360 for securing an advertisement for distribution throughout a network. The method 360 may be performed by a server or system having one or more processing devices and memory or non-transitory computer-readable media for storing computer logic that includes instructions for enabling the one or more processing devices to perform certain security functions. As shown in FIG. 11, the method 360 includes the step of receiving planned advertisement input from a remote user device associated with an advertiser, as indicated in block 362. The planned advertisement input, for example, may include textual and/or graphical elements of an ad in electronic form. Also, the planned advertisement input may further include a request for the ad to be displayed on one or more media devices. The method 360 also includes the step of storing the ad using one or more blockchain technologies to create a secured ad, as indicated in block 364. Also, the method 360 includes distributing the secured ad to the one or more media devices based on the request, as indicated in block 366.

The one or more media devices described in the method 360 may include one or more ticket printing devices. In other embodiments, the one or more media devices may include one or more of a digital billboard, a closed-circuit television, an end user device, a television, a radio, a mobile device, and a mobile billboard. The method 360 may also include the step of using the one or more blockchain technologies for performing one or more of encrypting, organizing, verifying, and embedding data associated with the ad. Also, the method 360 may include the step of storing Non-Fungible Tokens (NFTs) associated with the ad.

In some embodiments, the method 360 may also include the steps of a) categorizing multiple ads with respect to subject matter and b) assigning a blockchain-type attribute to each ad to identify and match the ads with the one or more media devices. The method 360 may also include the steps of a) determining a number of times that the ad is displayed on the one or more media devices, b) calculating, based on the number of times that the ad is displayed, a fee to be charged to the advertiser, and c) storing the calculated fee with the secured ad using the one or more blockchain technologies. The method 360 may also include receiving payment via cryptocurrency technologies when the one or more media devices displays the ad. The method 360 may also create smart contracts, blockchain files, and/or Non-Fungible Tokens (NFTs) for defining an originator of the ad. Also, the method 360 may identify ad spaces or locations with a blockchain element or Non-Fungible Token (NFT) element.

In some embodiments, the method 360 may be associated with a system that includes a network interface device that is configured to enable communication with the remote user device and the one or more media devices over a network. For example, the network may be one or more of a centralized network, a decentralized network, and a blockchain-based network that uses blockchain to track and verify the ad, the advertiser, and the one or more media devices. The one or more blockchain technologies may include at least a process of tracking the ad and verifying that the ad is displayed on the one or more media devices. The one or more blockchain technologies may include at least a process of tracking payments owed or paid by the advertiser.

FIG. 12 is a flow diagram illustrating an embodiment of a method 370 for securing an advertisement for distribution throughout a network. In this embodiment, the method 370 includes monitoring an advertisement that is distributed throughout a network and determine a number of times that the advertisement is displayed on one or more media devices in communication with the network, as indicated in block 372. Based on the number of times that the advertisement is displayed, the method 370 further includes calculating a fee to be charged to an advertiser, as indicated in block 374. The method 370 also includes storing the calculated fee with the advertisement using one or more blockchain technologies.

According to some embodiments, the method 370, prior to monitoring the advertisement (block 372), may include receiving planned advertisement input from a remote user device associated with the advertiser. Again, the planned advertisement input may include textual and/or graphical elements of the advertisement in electronic form and may further include a request for the advertisement to be displayed on a plurality of media devices in communication with the network. Prior to monitoring, the method 370 may also include storing the advertisement using the one or more blockchain technologies to create a secured ad and then distributing the secured advertisement to the one or more media devices based on the request. The method 370 may also include tracking a variety of billing elements and attributing payments from the advertiser to the billing elements.

### Displaying Advertisements According to Time Parameters

According to various systems and methods, an advertising system may include a plurality of electronic devices, an advertisement server configured to manage the display of a plurality of advertisements on the plurality of electronic devices, and at least one network configured to enable communication between the advertisement server and the plurality of electronic devices. Each of the plurality of electronic devices may be configured to display at least one of the plurality of advertisements according to predetermined time parameters when at least one advertiser intends for the advertisements to be displayed. Each of the plurality of electronic devices may be one of a digital billboard and a closed-circuit television.

In this respect, the advertising system includes features for displaying at least one of the plurality of advertisements according to predetermined time parameters. According to additional embodiments, advertisement systems and servers may be based on blockchain technology in combination with the above advertisement system using time parameters. For example, the blockchain-based advertisement system may include an advertisement server having a processing device and memory configured to store computer logic having instructions that enable the processing device to perform certain steps of a method.

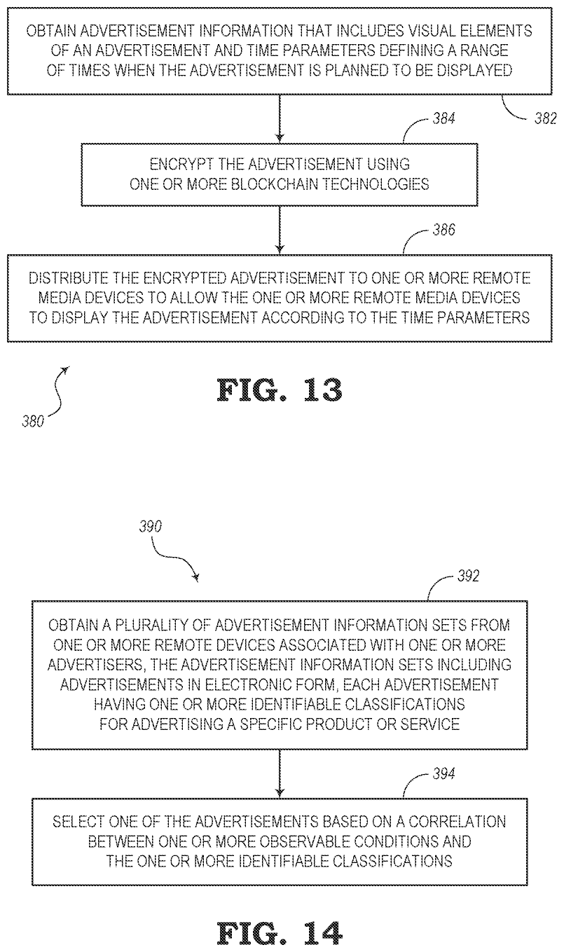

FIG. 13 is a flow diagram illustrating a method 380 for displaying advertisements, secured by blockchain, according to certain time parameters. As shown, the method 380 includes a step of obtaining advertisement information that includes visual elements of an advertisement and time parameters defining a range of times when the advertisement is planned to be displayed, as indicated in block 382. The method 380 also includes the step of encrypting the advertisement using one or more blockchain technologies, as indicated in block 384. Also, the method 380 includes the step of distributing the encrypted advertisement to one or more remote media devices to allow the one or more remote media devices to display the advertisement according to the time parameters, as indicated in block 386.

In some embodiments, the method 380 may be defined whereby the advertisement information further includes location parameters defining one or more areas where the advertisement is planned to be displayed. The one or more remote media devices may include ticket printing devices and/or mobile phones. The advertisement information may be received from a remote user device associated with an advertiser. The method 380 may also include the step of assisting the remote user device with a process of creating the advertisement. In some embodiments, the advertisement information may further include distribution parameters, where the distribution parameters can be programmable to enable distribution of the advertisement based on one or more of a type of ticket on which the advertisement is intended to be printed and a type of product associated with the advertisement.

### Targeting Advertisements to Specific Audiences

The present disclosure further describes additional systems and methods for targeting advertisements to certain groups of people or audiences. In some cases, this specific targeting may be based on what type of ticket a customer is purchasing and/or other items that the customer is purchasing (e.g., gas, food, cigarettes, lighter, etc.) at the same time or in the same transaction.

In some cases, targeted advertising can be based on various “conditions.” In a sense, this type of distinction may be referred to as condition-based targeting. For example, this condition-based targeting may depend on knowing the location of a customer at a certain time and what things are happening at or near the location of the customer at about the same time that the customer is making a purchase. Conditional advertising may be based on the current temperature, current weather conditions, weather forecasts, etc. The conditional features can also include knowing if some detectable parameter (e.g., temperature, rainfall, snowfall, forecasted weather, etc.) is higher than or lower than a certain threshold (e.g., temperature above or below a certain level, rainfall/snowfall above a certain amount, rain/snow forecast above a certain amount, etc.).

The conditional features can also include traffic conditions, current events, local events, upcoming events, etc. The conditions may include time of the day, day of the week, month of the year, season of the year, whether or not it is a school day, whether or not the day is a holiday or whether or not the day is near a holiday, etc. It can also depend on supply/demand figures and/or other detectable conditions, events, states, etc.

In some cases, the process of detecting and utilizing conditions or states may be based on Artificial Intelligence (AI). For example, training of an AI model may include supervised and/or unsupervised training. Once the AI model is trained, real-world parameters may be used to re-train or modify the AI model as needed. The use of the AI model may include any suitable algorithms or techniques for analyzing current conditions, location parameters, time parameters, purchase information, etc. This information can be compared with available advertisement campaigns stored in the system, where a matching advertisement can be displayed (e.g., printed on a ticket, displayed on screen of a computing device, etc.). Also, updated advertisement success information may be obtained based on what advertisements were displayed, the time they were displayed, the locations where they were displayed, and estimated sales figures that can be attributed to the advertisement. The success information can then be fed back to the AI system to tune the AI model as needed.

Thus, the advertisement systems and servers may include AI for determining how to target the advertisements. In some cases, the advertiser may select certain anticipated and/or monitored options, such as specific weather conditions, times of the day, etc. AI might also be used to detect patterns that may not be anticipated. In an unsupervised training scenario, advertisers may learn any type of unanticipated correlations from the AI training. As one example, it may be determined that people who purchase Pick 4 lottery tickets tend to buy more ice cream on sunny weekend afternoons in February when the temperature is above 60 degrees, but tend to buy less ice cream on overcast Friday evenings in July regardless of the temperature.

FIG. 14 is a flow diagram illustrating an embodiment of a method 390 for providing advertisements to targeted audiences. As illustrated, the method 390 includes the step of obtaining a plurality of advertisement information sets from one or more remote devices associated with one or more advertisers, as indicated in block 392. The advertisement information sets may include advertisements in electronic form, where each advertisement has one or more identifiable classifications for advertising a specific product or service. The method 390 also includes the step of selecting one of the advertisements based on a correlation between one or more observable conditions and the one or more identifiable classifications, as indicated in block 394.

The step of selecting the advertisement based on the correlation (block 394) may include targeting a customer making a purchase. The one or more observable conditions may include a type of ticket that the customer is purchasing and/or other items that the customer is purchasing during a single transaction. The one or more observable conditions may also include the location of the customer at a certain time and current activities happening near the customer.

The one or more observable conditions may include current temperature, current weather conditions, and/or weather forecasts. The method 390 may also include obtaining measurable conditions and determining if the measurable conditions are above a certain upper threshold or below a certain lower threshold. The one or more observable conditions may be obtained by a mobile device associated with a purchaser.

Furthermore, the one or more observable conditions may include traffic conditions, current events, local events, and/or upcoming events. The one or more observable conditions may be obtained by a mobile device associated with a purchaser.

The one or more observable conditions may also include the current time of the day, current day of the week, current month of the year, current season of the year, whether or not the current day is a school day, whether or not the current day is a holiday, and/or other time-related parameters. The one or more observable conditions again may be obtained by a mobile device associated with a purchaser. In some embodiments, the one or more observable conditions may include supply and demand parameters.

The method 390 may use an Artificial Intelligence (AI) algorithm to select the advertisement. In some embodiments, the method 390 may include performing unsupervised training to train the AI algorithm.

### CONCLUSION

It should be understood that the various servers and systems for managing tickets and/or advertisements (i.e., ticket managing server 12, 32, 102, 220, ticket/advertisement managing system 52, 82, advertisement managing system 40, 104, 120, advertisement server 304, 324, etc.), described throughout the present disclosure, may each include one or more computers, servers, computing systems, processing systems, etc. to perform the functions described herein.

It should be understood that the routines, steps, processes, or operations described herein may represent any module or code sequence that can be implemented in software or firmware. In this regard, these modules and code sequences can include commands or instructions for executing the specific logical routines, steps, processes, or operations within physical components. It should further be understood that two or more of the routines, steps, processes, and/or operations described herein may be executed substantially simultaneously or in a different order than explicitly described, as would be understood by one of ordinary skill in the art.

The implementations described herein represent a number of possible implementations and examples and are not intended to necessarily limit the present disclosure to any specific implementations. Instead, various modifications can be made to these implementations as would be understood by one of ordinary skill in the art. Any such modifications are intended to be included within the spirit and scope of the present disclosure and protected by the following claims.

What is claimed is:

1. A system comprising:
a processing device, and
a memory device configured to store a computer program having instructions that, when executed, enable the processing device to
receive planned advertisement input from a remote user device associated with an advertiser, the planned advertisement input including textual and/or graphical elements of an ad in electronic form, the planned advertisement input further including a request for the ad to be displayed on one or more media devices;
store the ad using one or more blockchain technologies to create a secured ad; and
distribute the secured ad to the one or more media devices based on the request.

2. The system of claim 1, wherein the one or more media devices include one or more ticket printing devices.

3. The system of claim 1, wherein the one or more media devices include one or more of a digital billboard, a closed-circuit television, an end user device, a television, a radio, a mobile device, and a mobile billboard.

4. The system of claim 1, wherein the instructions further enable the processing device to use the one or more blockchain technologies for performing one or more of encrypting, organizing, verifying, and embedding data associated with the ad.

5. The system of claim 4, wherein the instructions further enable the processing device to store Non-Fungible Tokens (NFTs) associated with the ad.

6. The system of claim 1, wherein the instructions further enable the processing device to:
categorize multiple ads with respect to subject matter; and
assign a blockchain-type attribute to each ad to identify and match the ads with the one or more media devices.

7. The system of claim 1, wherein the instructions further enable the processing device to:
determine a number of times that the ad is displayed on the one or more media devices;
based on the number of times that the ad is displayed, calculate a fee to be charged to the advertiser; and
store the calculated fee with the secured ad using the one or more blockchain technologies.

8. The system of claim 1, wherein the instructions further enable the processing device to receive payment via cryptocurrency technologies when the one or more media devices displays the ad.

9. The system of claim 1, wherein the instructions further enable the processing device to create smart contracts, blockchain files, and/or Non-Fungible Tokens (NFTs) for defining an originator of the ad.

10. The system of claim 1, wherein the instructions further enable the processing device to identify ad spaces or locations with a blockchain element or Non-Fungible Token (NFT) element.

11. The system of claim 1, further comprising a network interface device configured to enable communication with the remote user device and the one or more media devices over a network.

12. The system of claim 11, wherein the network is one or more of a centralized network, a decentralized network, and a blockchain-based network that uses blockchain to track and verify the ad, the advertiser, and the one or more media devices.

13. The system of claim 1, wherein the one or more blockchain technologies include at least a process of tracking the ad and verifying that the ad is displayed on the one or more media devices.

14. The system of claim 1, wherein the one or more blockchain technologies include at least a process of tracking payments owed or paid by the advertiser.

15. The system of claim 1, wherein the computer program is related to a blockchain smart contract.

16. A system comprising:
a processing device, and
a memory device configured to store a computer program having instructions that, when executed, enable the processing device to
monitor an advertisement that is distributed throughout a network and determine a number of times that the advertisement is displayed on one or more media devices in communication with the network;
calculate a fee to be charged to an advertiser based on the number of times that the advertisement is displayed; and
store the calculated fee using one or more blockchain technologies and reference the calculated fee to the advertisement.

17. The system of claim 16, wherein, prior to monitoring the advertisement, the instructions further enable the processing device to:
receive planned advertisement input from a remote user device associated with the advertiser, the planned advertisement input including textual and/or graphical elements of the advertisement in electronic form, the planned advertisement input further including a request for the advertisement to be displayed on a plurality of media devices in communication with the network;
store the advertisement using the one or more blockchain technologies to create a secured ad; and
distribute the secured advertisement to the one or more media devices based on the request.

18. The system of claim 16, wherein the instructions further enable the processing device to track a variety of billing elements and attribute payments from the advertiser to the billing elements.

19. The system of claim 16, wherein the computer program is related to a blockchain smart contract.

20. An advertisement server comprising:
a processing device; and
memory configured to store computer logic having instructions that enable the processing device to perform the steps of
obtaining advertisement information that includes visual elements of an advertisement and time parameters defining a range of times when the advertisement is planned to be displayed,
encrypting the advertisement using one or more blockchain technologies, and
distributing the encrypted advertisement to one or more remote media devices to allow the one or more remote media devices to display the advertisement according to the time parameters.

21. The advertisement server of claim 20, wherein the advertisement information further includes location parameters defining one or more areas where the advertisement is planned to be displayed.

22. The advertisement server of claim 20, wherein the one or more remote media devices include one or more of ticket printing devices and mobile phones.

23. The advertisement server of claim 20, wherein the advertisement information is received from a remote user device associated with an advertiser, and wherein the instructions further enable the processing device to assist the remote user device with a process of creating the advertisement.

24. The advertisement server of claim 20, wherein the advertisement information further includes distribution parameters, wherein the distribution parameters are programmable to enable distribution of the advertisement based on one or more of a type of ticket on which the advertisement is intended to be printed and a type of product related to the advertisement.

25. An advertisement server comprising:
a processing device; and
memory configured to store computer logic having instructions that enable the processing device to
obtain a plurality of advertisement information sets from one or more remote devices associated with one or more advertisers, the advertisement information sets including advertisements in electronic form, each advertisement having one or more identifiable classifications for advertising a specific product or service, and
select one of the advertisements based on a correlation between one or more observable conditions and the one or more identifiable classifications.

26. The advertisement server of claim 25, wherein selecting the advertisement based on the correlation includes targeting a customer making a purchase.

27. The advertisement server of claim 25, wherein the one or more observable conditions include one or more of a type of ticket that the customer is purchasing and other items that the customer is purchasing during a single transaction.

28. The advertisement server of claim 25, wherein the one or more observable conditions include one or more of a location of the customer at a certain time and current activities happening near the customer.

29. The advertisement server of claim 25, wherein the one or more observable conditions includes one or more of current temperature, current weather conditions, and weather forecasts.

30. The advertisement server of claim 29, wherein the instructions further enable the processing device to obtain measurable conditions and determine if the measurable conditions are above a certain upper threshold or below a certain lower threshold.

31. The advertisement server of claim 29, wherein the one or more observable conditions are obtained by a mobile device associated with a purchaser.

32. The advertisement server of claim 25, wherein the one or more observable conditions includes one or more of traffic conditions, current events, local events, and upcoming events.

33. The advertisement server of claim 32, wherein the one or more observable conditions are obtained by a mobile device associated with a purchaser.

34. The advertisement server of claim 25, wherein the one or more observable conditions includes one or more of current time of the day, current day of the week, current month of the year, current season of the year, whether or not the current day is a school day, and whether or not the current day is a holiday.

35. The advertisement server of claim 34, wherein the one or more observable conditions are obtained by a mobile device associated with a purchaser.

36. The advertisement server of claim 25, wherein the one or more observable conditions includes supply and demand parameters.

37. The advertisement server of claim 25, wherein the instructions further enable the processing device to use an Artificial Intelligence (AI) algorithm to select the advertisement.

38. The advertisement server of claim 37, wherein the instructions further enable the processing device to perform unsupervised training to train the AI algorithm.
